(19) United States
(12) Patent Application Publication
(10) Pub. No.: US 2026/0032084 A1
(43) Pub. Date: Jan. 29, 2026

(54) SCHEDULING METHOD, ELECTRONIC DEVICE, AND STORAGE MEDIUM FOR MANAGING NETWORK CONGESTION

(71) Applicant: TENCENT TECHNOLOGY (SHENZHEN) COMPANY LIMITED, Shenzhen (CN)

(72) Inventors: Jianming WANG, Shenzhen (CN); Xuefeng JI, Shenzhen (CN); Guozhi SHAN, Shenzhen (CN); Zhaohe CHEN, Shenzhen (CN); Borui FU, Shenzhen (CN); Xiaoyuan HU, Shenzhen (CN); Weizhen DANG, Shenzhen (CN)

(21) Appl. No.: 19/346,660

(22) Filed: Oct. 1, 2025

Related U.S. Application Data
(63) Continuation of application No. PCT/CN2024/109871, filed on Aug. 5, 2024.

(30) Foreign Application Priority Data
Sep. 28, 2023 (CN) 202311288644.0

(51) Int. Cl. H04L 47/122; H04L 43/0882

(52) U.S. Cl. CPC H04L 47/122; H04L 43/0882

(57) ABSTRACT

A scheduling method for managing network congestion includes: determining, in response to link congestion in a network, a plurality of queue pairs (QPs) on a congested link in the network; determining, from the plurality of QPs on the congested link, a target QP for scheduling out from the congested link; determining a target traffic-forwarding path based on traffic of links in the network, the target traffic-forwarding path being configured for forwarding traffic of the target QP; determining a changed route of the target QP based on a target address of the target QP and the target traffic-forwarding path; and delivering the changed route to a target source local area network access (LA) device of the target QP, the target source LA device being configured to output, based on the changed route, the traffic of the target QP through the target traffic-forwarding path.

### CROSS-REFERENCES TO RELATED APPLICATIONS

This application is a continuation application of PCT Patent Application No. PCT/CN2024/109871, filed on Aug. 5, 2024, which claims priority to Chinese Patent Application No. 202311288644.0, filed on Sep. 28, 2023, all of which is incorporated herein by reference in their entirety.

### FIELD OF THE TECHNOLOGY

The present disclosure relates to the technical field of communication and, in particular, to a scheduling method for managing network congestion, an electronic device, a storage medium, and a program product.

### BACKGROUND OF THE DISCLOSURE

With the rapid increase in the number of internet users, the problem of network congestion has emerged. Network congestion occurs when too many data packets arrive within a certain period of time, and network devices such as routers are unable to process these data packets in time. Consequently, these data packets accumulate in the buffer, leading to increased transmission delay. The increase in the delay, in turn, reduces the network's ability to process the data packets, creating a cycle that causes transmission efficiency to drop sharply and leads to network congestion.

Currently, when network congestion occurs, troubleshooting and fault localization can only rely on manual intervention, or else the network must be left to recover on its own. However, manual troubleshooting is time-consuming.

### SUMMARY

One embodiment of the present disclosure provides a scheduling method for managing network congestion, which is applied to an electronic device and includes: determining, in response to link congestion in a network, a plurality of queue pairs (QPs) on a congested link in the network; determining, from the plurality of QPs on the congested link, a target QP for scheduling out from the congested link; determining a target traffic-forwarding path based on traffic of links in the network, the target traffic-forwarding path being configured for forwarding traffic of the target QP; determining a changed route of the target QP based on a target address of the target QP and the target traffic-forwarding path; and delivering the changed route to a target source local area network access (LA) device of the target QP, the target source LA device being configured to output, based on the changed route, the traffic of the target QP through the target traffic-forwarding path.

Another embodiment of the present disclosure provides an electronic device. The electronic device includes one or more processors and a memory containing a computer-executable instruction that, when being executed, causes the one or more processors to perform: determining, in response to link congestion in a network, a plurality of queue pairs (QPs) on a congested link in the network; determining, from the plurality of QPs on the congested link, a target QP for scheduling out from the congested link; determining a target traffic-forwarding path based on traffic of links in the network, the target traffic-forwarding path being configured for forwarding traffic of the target QP; determining a changed route of the target QP based on a target address of the target QP and the target traffic-forwarding path; and delivering the changed route to a target source local area network access (LA) device of the target QP, the target source LA device being configured to output, based on the changed route, the traffic of the target QP through the target traffic-forwarding path.

Another embodiment of the present disclosure provides a non-transitory computer-readable storage medium containing a computer program that, when being executed, causes at least one processor to perform: determining, in response to link congestion in a network, a plurality of queue pairs (QPs) on a congested link in the network; determining, from the plurality of QPs on the congested link, a target QP for scheduling out from the congested link; determining a target traffic-forwarding path based on traffic of links in the network, the target traffic-forwarding path being configured for forwarding traffic of the target QP; determining a changed route of the target QP based on a target address of the target QP and the target traffic-forwarding path; and delivering the changed route to a target source local area network access (LA) device of the target QP, the target source LA device being configured to output, based on the changed route, the traffic of the target QP through the target traffic-forwarding path.

### BRIEF DESCRIPTION OF THE DRAWINGS

FIG. 1 is a schematic architectural diagram of a business system according to an embodiment of the present disclosure.

FIG. 2A is a first schematic structural diagram of an electronic device according to an embodiment of the present disclosure.

FIG. 2B is a second schematic structural diagram of an electronic device according to an embodiment of the present disclosure.

FIG. 3A is a first schematic flowchart of a scheduling method for managing network congestion according to an embodiment of the present disclosure.

FIG. 3B is a second schematic flowchart of a scheduling method for managing network congestion according to an embodiment of the present disclosure.

FIG. 3C is a third schematic flowchart of a scheduling method for managing network congestion according to an embodiment of the present disclosure.

FIG. 3D is a fourth schematic flowchart of a scheduling method for managing network congestion according to an embodiment of the present disclosure.

FIG. 3E is a fifth schematic flowchart of a scheduling method for managing network congestion according to an embodiment of the present disclosure.

FIG. 3F is a sixth schematic flowchart of a scheduling method for managing network congestion according to an embodiment of the present disclosure.

FIG. 3G is a seventh schematic flowchart of a scheduling method for managing network congestion according to an embodiment of the present disclosure.

FIG. 3H is an eighth schematic flowchart of a scheduling method for managing network congestion according to an embodiment of the present disclosure.

FIG. 4A is a first schematic diagram of a network architecture according to an embodiment of the present disclosure.

FIG. 4B is a second schematic diagram of a network architecture according to an embodiment of the present disclosure.

FIG. 5 is a schematic diagram of high performance computing (HPC) according to an embodiment of the present disclosure.

FIG. 6 is a schematic diagram of a classic fat-tree network architecture according to an embodiment of the present disclosure.

FIG. 7 is a schematic diagram of an HPC Layer 2 network architecture during load balancing according to an embodiment of the present disclosure.

FIG. 8 is a schematic diagram of an HPC Layer 2 network architecture during network congestion according to an embodiment of the present disclosure.

FIG. 9 is a daily traffic curve of a link from an LA device to an LC device according to an embodiment of the present disclosure.

FIG. 10 is an explicit congestion notification (ECN) daily statistical curve of a link from an LA device to an LC device according to an embodiment of the present disclosure.

FIG. 11 is a network structure diagram of link congestion after a downstream link from an LC device to an LA device fails according to an embodiment of the present disclosure.

FIG. 12 is a schematic diagram of an HPC Layer 3 network architecture during load balancing according to an embodiment of the present disclosure.

FIG. 13 is a schematic diagram of a Layer 3 network architecture for rerouting after a downstream link from an LC device to an LA device fails according to an embodiment of the present disclosure.

FIG. 14 is a schematic diagram of an HPC Layer 3 network architecture during network congestion according to an embodiment of the present disclosure.

FIG. 15 is a schematic diagram of an HPC Layer 3 network architecture after a secondary fault according to an embodiment of the present disclosure.

FIG. 16 is an ECN statistical count change curve of a port according to an embodiment of the present disclosure.

FIG. 17 is a flowchart of a scheduling method for managing network congestion according to an embodiment of the present disclosure.

FIG. 18 is a flowchart of a Layer 2 network architecture congestion scheduling method according to an embodiment of the present disclosure.

FIG. 19 is a schematic diagram of a Layer 2 network architecture according to an embodiment of the present disclosure.

FIG. 20 is a flowchart of a Layer 3 network architecture congestion scheduling method according to an embodiment of the present disclosure.

FIG. 21 is an ECN statistical count change curve after a scheduling method provided in an embodiment of the present disclosure is adopted.

### DESCRIPTION OF EMBODIMENTS

To make the objectives, technical solutions, and advantages of the present disclosure clearer, the present disclosure will be described in further detail below with reference to the accompanying drawings. The described embodiments are not to be considered as a limitation to the present disclosure. All other embodiments obtained by a person skilled in the art without creative efforts shall fall within the protection scope of the present disclosure.

The term, involved in the following description, “first/second” is merely intended to distinguish similar objects rather than describing specific orders. The “first/second” is interchangeable in proper circumstances to enable the embodiments of the present disclosure to be implemented in other orders than those illustrated or described herein.

Unless defined otherwise, all technical and scientific terms used herein have the same meaning as commonly understood by a person skilled in the art to which the present disclosure belongs. Terms used herein are merely intended to describe the embodiments of the present disclosure, but are not intended to limit the present disclosure.

Before the embodiments of the present disclosure are further described in detail, nouns and terms involved in the embodiments of the present disclosure are described. The nouns and terms involved in the embodiments of the present disclosure are applicable to the following explanations.
1) HPC: it provides more powerful computing performance than traditional computers or servers by aggregating computing capabilities, and is mainly applied to fields such as scientific research, weather forecasting, artificial intelligence (AI), and image processing.
2) Graphics processing unit (GPU): it is alternatively referred to as a graphics card or a GPU card. Microprocessors, which specially perform operations related to images and graphics on personal computers (PCs), servers, and game machines, are also widely applied to fields such as scientific computing and AI.
3) Remote direct memory access (RDMA): it is a technology in which an operating system kernel of a remote host is bypassed to access data in a memory of the remote host. Since the operating system is not used, a large amount of central processing unit (CPU) resources is saved. Meanwhile, the system throughput is improved, and the network communication delay of the system is reduced. It is especially suitable for a scene involving massive parallel computing such as AI.
4) InfiniBand (IB): it is a computer network communication standard for HPC and has extremely high throughput and extremely low delay. The IB may be considered as a network specially designed for RDMA and is similar to the current mainstream Ethernet, but the IB is incompatible with the current mainstream Ethernet.
5) RDMA over converged Ethernet (RoCE): it is an RDMA technology based on the traditional Ethernet. Based on the ROCE, the RDMA technology with high speed, ultra-low delay, and extremely low CPU utilization is deployed on the most widely used Ethernet currently.
6) QP: work queues may be paired, and a queue pair (QP) includes a pair of work queues, which may include a send work queue (SQ) and a receive work queue (RQ). The QP is a basic unit of RDMA network communication.
7) ECN: when congestion occurs in a network, a transmission control protocol (TCP) actively discards data packets and then ensures reliable transmission through retransmission and confirmation. However, the ECN reduces the number of packet losses in the network to avoid retransmission, thereby enabling a sender to actively reduce the packet transmission rate.
8) Network traffic detection technology sampled flow (sFlow): it is a network traffic detection technology based on packet sampling and is mainly configured for statistical analysis of the network traffic. The sFlow provides interface-based traffic analysis and may detect a traffic condition in real time to discover sources of abnormal traffic and attack traffic in time.
9) High-speed data acquisition technology (telegraphy): it is a technology of remotely acquiring data from a switch at a high speed. The switch periodically and actively uploads information such as port traffic statistics, CPU data, or memory data of the device to an acquisition module through a push mode, which provides a more real-time and high-speed data acquisition function compared with a question-and-answer interaction of a traditional pull mode such as snmp acquisition.
10) Border gateway protocol (BGP): it is a dynamic routing protocol that realizes routing reachability between autonomous systems (ASs) and selects an optimal route. It is the basis of Internet communication.
11) AI: it refers to a large and complex neural network that needs to store more parameters to increase the depth and width of a model, thereby improving the performance capability of the model. There are at least tens of billions of parameters. The large amount of data is trained, and a prediction result of high quality is generated.

The embodiments of the present disclosure provide a scheduling method for managing network congestion and apparatus, an electronic device, a computer-readable storage medium, and a computer program product, which may schedule some traffic on a congested link when link congestion occurs in a network, to resolve the problem of network congestion.

Exemplary application of an electronic device provided in the embodiments of the present disclosure is described below. The electronic device provided in the embodiments of the present disclosure may be implemented as various types of computer devices including a controller, such as servers and terminals. Exemplary application in which the electronic device is implemented as a server is described below.

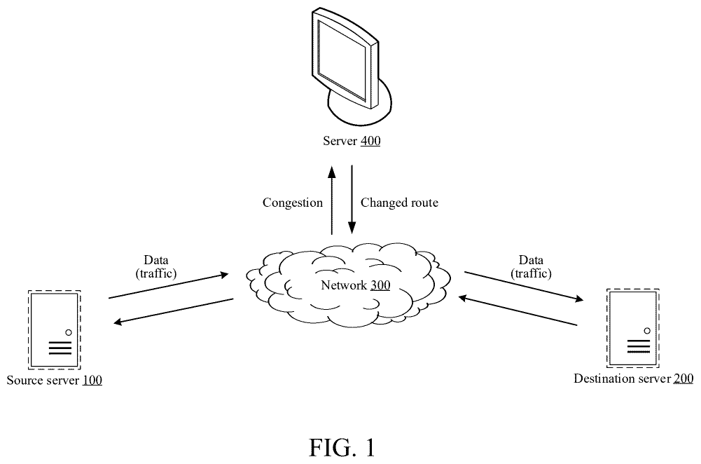

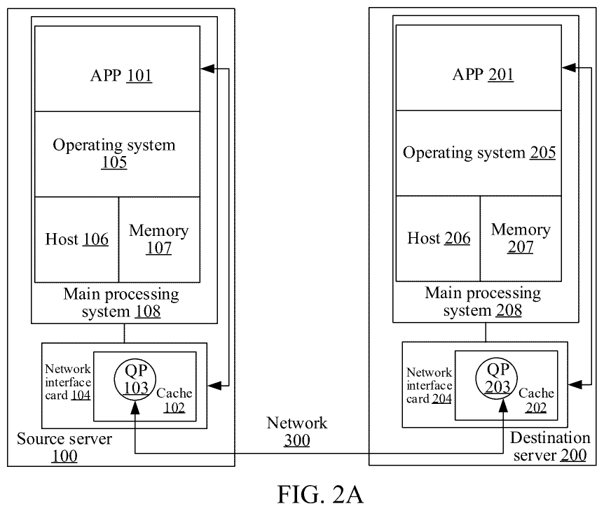

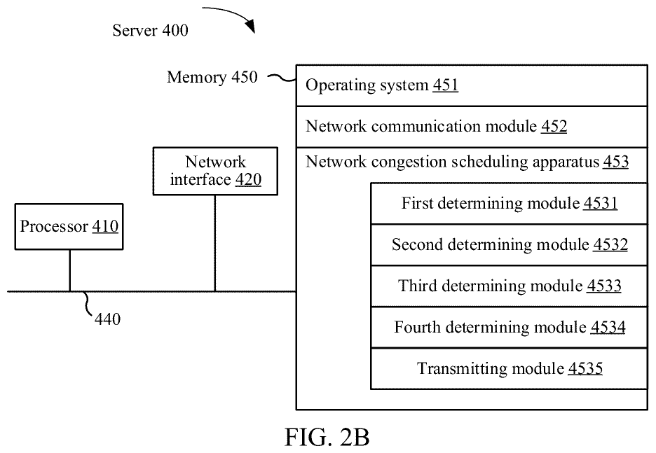

FIG. 1 is a schematic architectural diagram of a business system 10 according to an embodiment of the present disclosure. The business system 10 may include a source server 100, a destination server 200, a network 300, and a server 400. The source server 100 communicates with the destination server 200 through the network 300. The network 300 may be a wide area network, a local area network, or a combination of the two. A communication process between the source server 100 and the destination server 200 is described below with reference to FIG. 2A. The communication process between the source server 100 and the destination server 200 may alternatively be understood as a data transmission process between the source server 100 and the destination server 200.

The source server 100 may contain a network interface card 104 and a main processing system 108. The main processing system 108 includes a host 106 (or a CPU) and a host memory 107 (conventional hardware of other computer systems, such as a hard disk and a bus, not shown in FIG. 2A). Various software components, such as an operating system 105 and an application (APP) 101 running on the operating system 105, further run on the main processing system 108. The destination server 200 contains a network interface card 204 and a main processing system 208. The main processing system 208 includes a host 206 (CPU) and a host memory 207. Various software components, such as an operating system 205 and an APP 201 running on the operating system 205, further run on the main processing system 208.

The network interface card 104 (which may alternatively be referred to as a network adapter or a communications adapter) includes a cache 102. A paired work queue may be provided in the cache 102 and may be referred to as QP. The QP is a virtual interface provided by the network interface card to the APP and includes an SQ and an RQ. The SQ and the RQ are always generated together and appear in a pair, and they will remain paired throughout their existence. An instruction transmitted by the APP to the network interface card is referred to as a work queue element (WQE). Before the APP 101 in the source server 100 transmits data to the APP 201 in the destination server 200 in an RDMA manner, the source server 100 and the destination server 200 first establish QP pairing, that is, the QP 103 and the QP 203 jointly implement data transmission between the APP 101 and the APP 201, and a corresponding queue pair identifier is added to data transmitted subsequently. Data is usually transmitted in a form of a packet. Therefore, in some application scenes, data transmitted between the source server 100 and the destination server 200 may alternatively be referred to as a packet. In a process of transmitting data from the source server 100 to the destination server 200 through the multi-path network 300, a routing device in the network selects a forwarding path according to five-tuple information in the data, thereby transmitting the data between the source server 100 and the destination server 200.

The server 400 monitors data transmission statuses of links in the network 300. Once link congestion occurs in the network 300, the server 400 determines, in response to link congestion occurring in the network, a plurality of QPs on a congested link in the network, determines a to-be-scheduled out QP on the congested link from the plurality of QPs on the congested link, determines, based on traffic of the links in the network, a target traffic-forwarding path configured for forwarding traffic of the to-be-scheduled out QP, and determines a changed route of the to-be-scheduled out QP based on a target address of the to-be-scheduled out QP and the target traffic-forwarding path. The server 400 delivers the changed route to the network 300. The network 300 transmits, based on the guidance of the changed route, traffic (data) outputted by the source server 100 to the destination server 200 after bypassing the congested link. Therefore, when link congestion occurs in the network, some traffic on the congested link is scheduled, to resolve the problem of network congestion quickly.

In some embodiments, the server may implement the scheduling method for managing network congestion provided in the embodiments of the present disclosure by running various computer-executable instructions or computer programs. For example, the computer-executable instruction may be a microprogram-level command, a machine instruction, or a software instruction. The computer program may be a native program or a software module in an operating system, may be a native APP, i.e., a program that needs to be installed in the operating system to run, such as an instant messaging APP, or may be a mini program that may be embedded in any APP, i.e., a program that only needs to be downloaded into a browser environment to run. In summary, the foregoing computer-executable instruction may be an instruction in any form, and the foregoing computer program may be an APP, a module, or a plug-in in any form.

FIG. 2B is a schematic structural diagram of an electronic device according to an embodiment of the present disclosure. Using the server 400 as an example, the electronic device 400 shown in FIG. 2B includes at least one processor 410, a memory 450, and at least one network interface 420. Components in the destination server 200 are coupled together through a bus system 440. The bus system 440 is configured to implement connection and communication among the components. In addition to a data bus, the bus system 440 further includes a power bus, a control bus, and a state signal bus. However, for clear description, various types of buses in FIG. 2B are marked as the bus system 440.

The processor 410 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any suitable processor, or the like.

The memory 450 may be removable, non-removable, or a combination thereof. Exemplary hardware devices include a solid-state memory, a hard disk drive, a compact disc (CD) drive, and the like. The memory 450 alternatively includes one or more storage devices physically located away from the processor 410.

The memory 450 includes a volatile memory or a non-volatile memory, or may include both the volatile memory and the non-volatile memory. The non-volatile memory may be a read only memory (ROM). The volatile memory may be a random access memory (RAM). The memory 450 described in this embodiment of the present disclosure is intended to include any suitable type of memory.

In some embodiments, the memory 450 can store data to support various operations. Examples of the data include a program, a module, and a data structure, or their subsets or supersets, which are exemplified below.

An operating system 451 includes a system program configured for processing various basic system services and performing hardware-related tasks, such as a framework layer, a core library layer, or a driver layer, to implement various basic businesses and process the hardware-based tasks.

A network communication module 452 is configured to connect to other computer devices via one or more (wired or wireless) network interfaces 420. The exemplary network interfaces 420 include Bluetooth, wireless fidelity (WiFi), a universal serial bus (USB), and the like.

In some embodiments, the apparatus provided in the embodiments of the present disclosure may be implemented in a software manner. FIG. 2B shows a network congestion scheduling apparatus 453 stored in the memory 450. The network congestion scheduling apparatus 453 may be software in the form of a program, a plug-in, or the like, and includes the following software modules: a first determining module 4531, a second determining module 4532, a third determining module 4533, a fourth determining module 4534, and a transmitting module 4535. These modules are logical, and therefore may be arbitrarily combined or further split according to implemented functions. The functions of the modules will be described below.

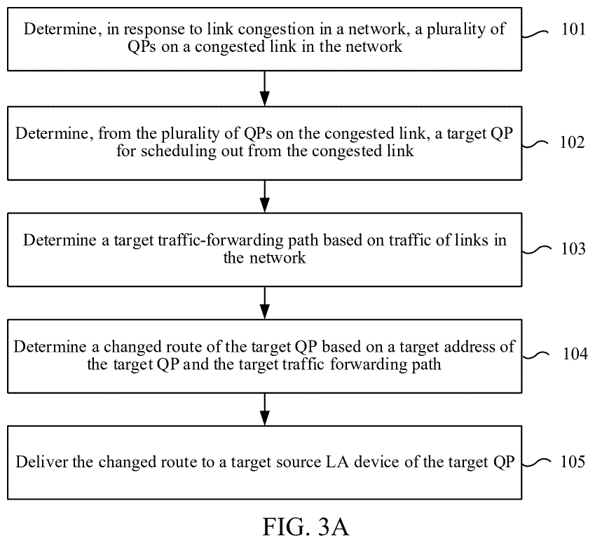

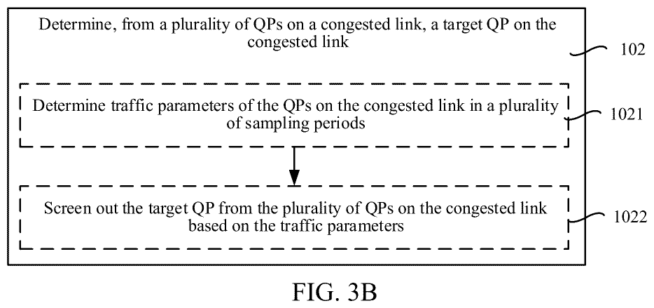

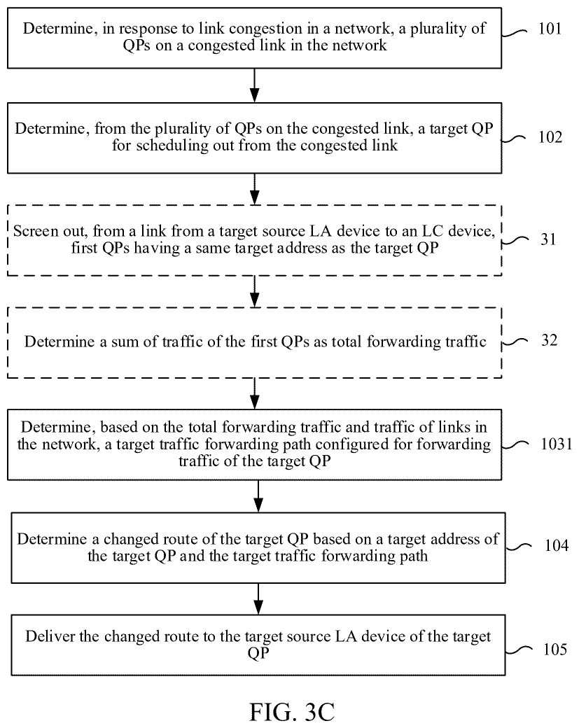

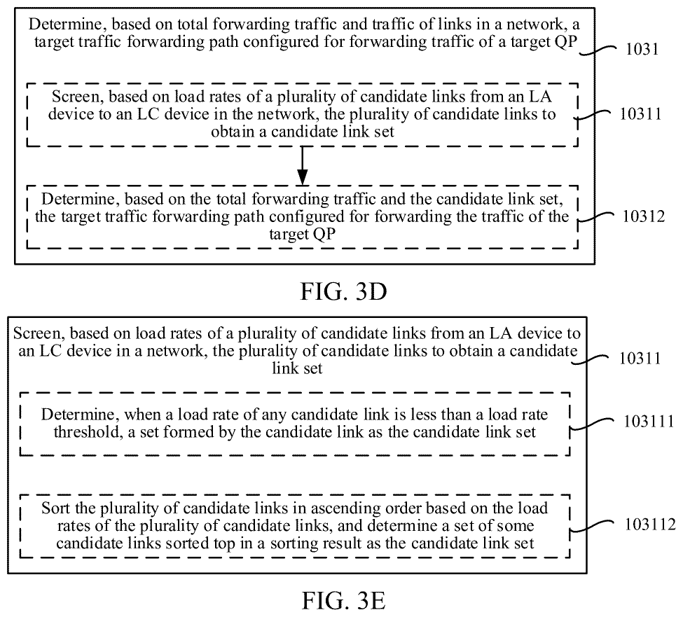

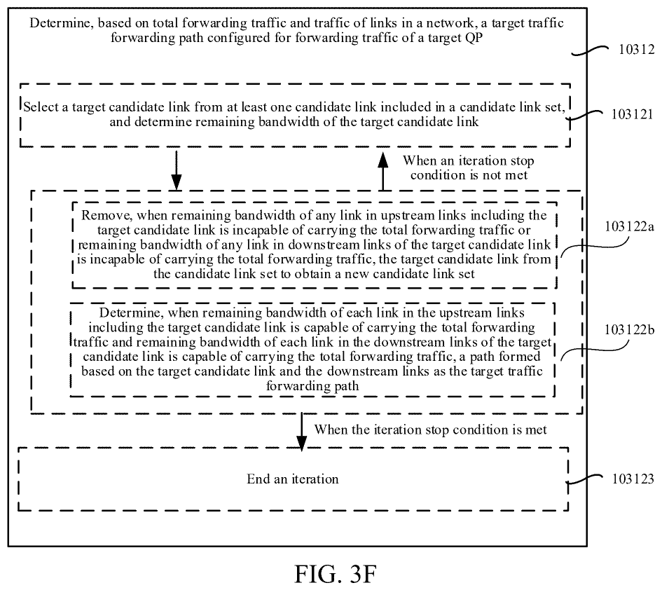

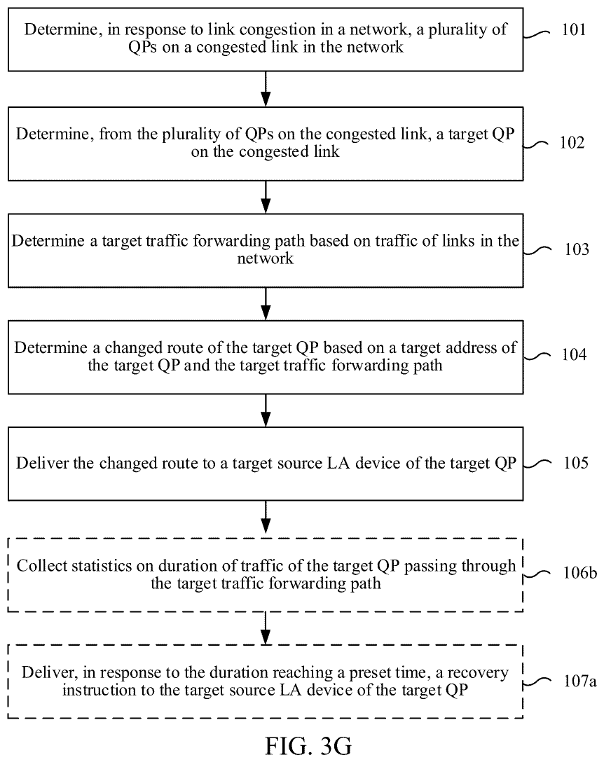

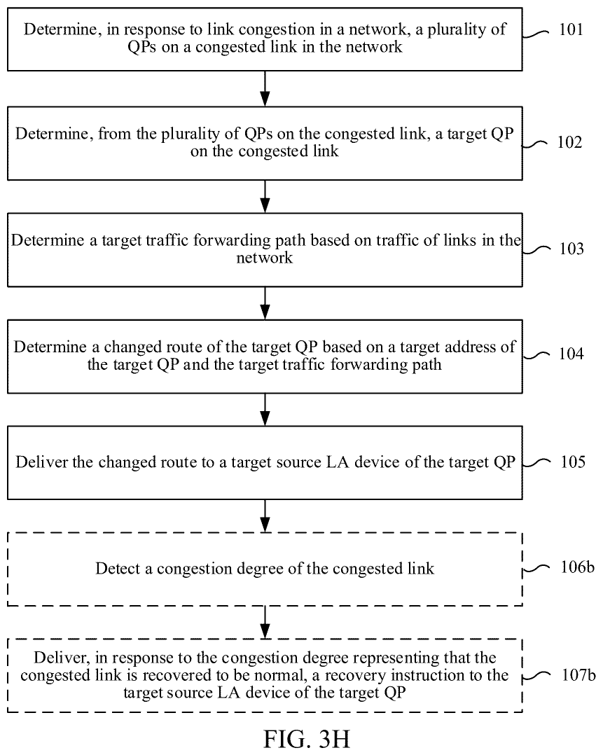

The scheduling method for managing network congestion provided in the embodiments of the present disclosure is described with reference to the exemplary application and implementations of the electronic device provided in the embodiments of the present disclosure. Descriptions are provided with reference to the operations shown in FIG. 3A. The scheduling method for managing network congestion includes operation 101 to operation 105.

Operation 101: Determine, in response to link congestion in a network, a plurality of QPs on a congested link in the network.

In this embodiment of the present disclosure, link congestion in a network may be understood as that a link in the network is congested. Congestion may be understood as that traffic needing to be transmitted by a link exceeds load of the link, and consequently, the traffic accumulates on the link, resulting in degradation of the entire network performance.

In this embodiment of the present disclosure, the link may be understood as a physical line between two nodes. The nodes are some network devices in the network. The network device may include, but is not limited to, a local area network (LAN) access device (also referred to as “LA device” or “LA”), a LAN core device (also referred to as “LC device” or “LC”), and a Super-LC (or Super-LC device). Correspondingly, links involved in this embodiment of the present disclosure may include: LA=>LC, LC=>Super-LC, Super-LC=>LC, LC=>LA, LA=>Super-LC, Super-LC=>LA, and Super-LC=>LC.

The congested link is a link congested in the network. An implementation of “detecting that link congestion occurs in the network” is not specifically limited in this embodiment of the present disclosure. When link congestion occurs in the network, an ECN count of a link is at a relatively high value (that is, the ECN count is greater than or equal to an ECN count threshold). The ECN count threshold may be a preset threshold and may be adjusted according to an actual requirement. In one embodiment, a congestion status of a link may be determined through the ECN count. Illustratively, if the ECN count is greater than or equal to the ECN count threshold, link congestion may be determined. In one embodiment, the congestion status of the link may be determined through a load status of the link. In this embodiment of the present disclosure, two implementations of “determining the congestion status of the link” are illustratively introduced, and the foregoing implementations do not constitute a specific limitation.

An execution body of the operation of “monitoring the congestion status of the link” is not specifically limited in this embodiment of the present disclosure. In one embodiment, the congestion status of the link may be detected using a detection module. In response to determining that link congestion occurs in the network, the detection module may transmit the ECN to the server. In another implementation, the detection module may be integrated inside the server, that is, the server detects the congestion status of the link.

In this embodiment of the present disclosure, one link may correspond to a plurality of QPs. The number of QPs on the link is not specifically limited in this embodiment of the present disclosure and may be configured according to requirements. Illustratively, there may be four QPs on one link.

The QP includes an SQ and an RQ. The SQ and the RQ are generated together and appear in a pair, and they will remain paired throughout their existence.

Operation 102: Determine, from the plurality of QPs on the congested link, a to-be-scheduled out QP on the congested link, e.g., a target QP for scheduling out from the congested link.

The to-be-scheduled out QP is one of the plurality of QPs.

FIG. 3B shows that operation 102 in FIG. 3A may be implemented through the following operation 1021 and operation 1022, which are described below in detail.

Operation 1021: Determine traffic parameters of the QPs on the congested link in a plurality of sampling periods.

An execution body of the operation of acquiring the traffic of the QPs is not specifically limited in this embodiment of the present disclosure. In one embodiment, the traffic of the QPs may be acquired using a flow acquisition module, and the flow acquisition module transmits the acquired traffic of the QPs to the server so that the server may read the traffic parameters of the traffic. In one embodiment, the flow acquisition module may be integrated inside the server, that is, the server independently acquires the traffic of the QPs and reads the parameters of the traffic.

The traffic parameter involved in this embodiment of the present disclosure includes one of the following: a traffic peak, an average traffic value, and a traffic value obtained after performing weighted summation on the traffic based on duration of the traffic in the plurality of sampling periods.

In this embodiment of the present disclosure, statistics on the traffic acquired in the plurality of sampling periods may be collected, and then the traffic acquired in the plurality of sampling periods is averaged to obtain the average traffic value of the QPs. The averaging may include, but is not limited to, arithmetic averaging, geometric averaging, or the like.

The average traffic value in this embodiment of the present disclosure may represent a congestion status of the QP. A to-be-scheduled out QP that is relatively congested among the plurality of QPs may be determined based on the average traffic value. Subsequently, traffic of the to-be-scheduled out QP is outputted through the target traffic-forwarding path, thereby effectively relieving network congestion.

In this embodiment of the present disclosure, a curve of the traffic changing with time may be drawn based on traffic acquired in one sampling period, and then a traffic peak in the sampling period is determined based on the curve.

The traffic peak in this embodiment of the present disclosure may represent a sudden congestion status in the QP. A to-be-scheduled out QP that is suddenly congested among the plurality of QPs may be determined based on the traffic peak. Subsequently, the traffic of the to-be-scheduled out QP is outputted through the target traffic-forwarding path, thereby accurately relieving network congestion.

In this embodiment of the present disclosure, statistics on duration corresponding to the traffic acquired in the plurality of sampling periods may be collected. The duration corresponding to the traffic in the plurality of sampling periods is mapped to obtain a weight of the traffic in each sampling period, and weighted summation is performed on the traffic based on the weight of the traffic in each sampling period to obtain a weighted summation traffic value of the QP in the sampling period.

The weighted summation traffic value in this embodiment of the present disclosure may accurately represent the congestion status of the QP (hereinafter referred to as “QP congestion status” for convenience of description). Based on the weighted summation traffic value, the to-be-scheduled out QP whose traffic needs to be forwarded among the plurality of QPs may be determined, thereby effectively relieving network congestion.

The sampling period may be a preset period for sampling the traffic of the QP and may be adjusted according to an actual requirement. The time of the plurality of sampling periods is not specifically limited in this embodiment of the present disclosure. In one embodiment, the plurality of sampling periods may be N sampling periods closest to the determined link congestion occurring in the network, where N is a positive integer greater than 1. In one embodiment, the plurality of sampling periods may be a plurality of sampling periods within a set time. For example, the traffic data may be acquired within a time period of 8:00-10:00 every day.

Operation 1022: Screen out the to-be-scheduled out QP from the plurality of QPs on the congested link based on the traffic parameters.

In this embodiment of the present disclosure, the congested link includes a plurality of QPs, and traffic of some QPs needs to be transferred to the target traffic-forwarding path for forwarding. In this embodiment of the present disclosure, the QP whose traffic needs to be forwarded on the congested link is referred to as the to-be-scheduled out QP.

An implementation of screening out the to-be-scheduled out QP from the plurality of QPs on the congested link based on the traffic parameters is not specifically limited in this embodiment of the present disclosure. For example, in one embodiment, a QP having a relatively large average traffic value (greater than an average traffic value threshold, which may be a preset threshold and may be adjusted according to an actual requirement) can be screened out as the to-be-scheduled out QP. In one embodiment, a QP whose traffic peak is greater than a peak threshold may be screened out from the plurality of QPs as the to-be-scheduled out QP. The peak threshold may be a preset threshold and may be adjusted according to an actual requirement. In one embodiment, a QP whose weighted traffic value is greater than a traffic value threshold may be screened out as the to-be-scheduled out QP. The traffic value threshold may be a preset threshold and may be adjusted according to an actual requirement.

In some embodiments, a load rate of each QP on the congested link may further be acquired. The to-be-scheduled out QP is screened out from the plurality of QPs on the congested link based on the load rate. Illustratively, a QP having a highest load rate on the congested link may be used as the to-be-scheduled out QP.

In this embodiment of the present disclosure, several implementations of determining, from the plurality of QPs on the congested link, the to-be-scheduled out QP on the congested link are illustratively introduced, and the foregoing implementations do not constitute a specific limitation.

Operation 103: Determine a target traffic-forwarding path based on traffic of links in the network, the target traffic-forwarding path being configured for forwarding traffic of the to-be-scheduled out QP.

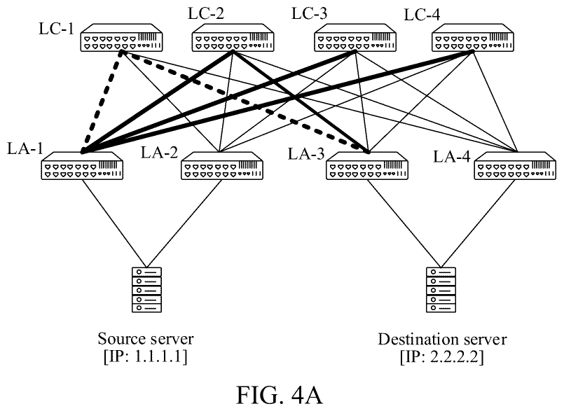

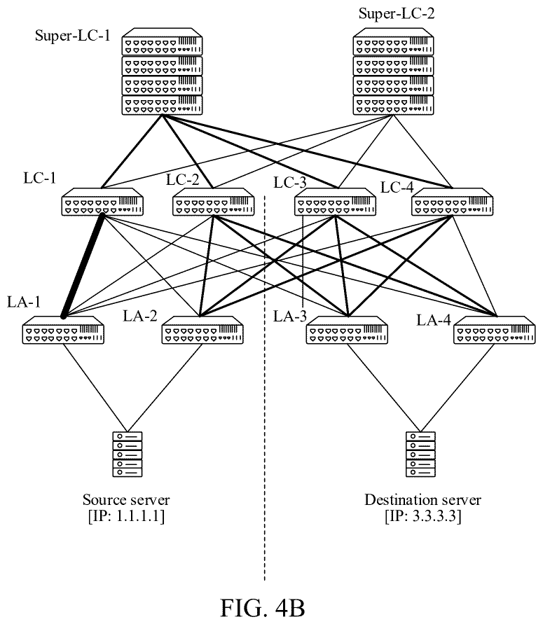

In this embodiment of the present disclosure, the path may be understood as a passage connecting the source server and the destination server and is configured for traffic transmission. An LA connected to the source server on the path is referred to as a source LA, and an LA connected to the destination server on the path is referred to as a destination LA. Illustratively, referring to FIG. 4A, the LA-1 and the LA-2 are source LAs, and the LA-3 and the LA-4 are destination LAs.

The target traffic-forwarding path is a path configured for forwarding the traffic of the to-be-scheduled out QP. One end of the target traffic-forwarding path is connected to a source server of the to-be-scheduled out QP, and the other end of the target traffic-forwarding path is connected to a destination server of the to-be-scheduled out QP.

Illustratively, referring to FIG. 4A, an original path of the to-be-scheduled out QP is: LA-1=>LC-1=>LA-3. The source server of the to-be-scheduled out QP is a source server (for example, IP: 1.1.1.1), and the destination server of the to-be-scheduled out QP is a destination server (for example, IP: 2.2.2.2).

Following the foregoing example, LA-1=>LC-2=>LA-3 may be used as the target traffic-forwarding path of the to-be-scheduled out QP. A source server of LA-1=>LC-2=>LA-3 is the source server (IP: 1.1.1.1), and a destination server of LA-1=>LC-2=>LA-3 is the destination server (IP: 2.2.2.2).

The embodiments of the present disclosure further provide an implementation of determining the target traffic-forwarding path. Referring to FIG. 3C, before operation 103 in FIG. 3A is shown in FIG. 3C, operation 31 to operation 32 may be performed, and operation 103 in FIG. 3A may be implemented by performing operation 1031, which is described below in detail.

Operation 31: Screen out, on a link from the target source LA to an LC, first QPs having a same target address as the to-be-scheduled out QP.

The target source LA is an LA (for example, a switch located in an access layer) connected to the source server configured to output the traffic of the to-be-scheduled out QP. The first QPs having the same target address as the to-be-scheduled out QP are screened out on the link from the target source LA to the LC based on the following two considerations.

A first consideration is that the target address is configured for indicating that the traffic reaches a specified destination server. In this embodiment of the present disclosure, a QP having the same target address as the to-be-scheduled out QP is first determined. For ease of description, in this embodiment of the present disclosure, the QP having the same target address as the to-be-scheduled out QP is referred to as the first QP. The first QP and the to-be-scheduled out QP have the same target address. Therefore, traffic of the first QP and traffic of a to-be-forwarded QP are transmitted to the same destination server. Thus, the traffic of the first QP and the traffic of the to-be-forwarded work queue may be forwarded to the destination server together.

A second consideration is that the first QPs having the same target address as the to-be-scheduled out QP are screened out on the link from the target source LA to the LC to ensure that traffic outputted by the first QPs from the target source LA is forwarded, thereby reducing a risk of secondary congestion.

This embodiment of the present disclosure is not limited to screening out, on the link from the target source LA to the LC, the first QPs having the same target address as the to-be-scheduled out QP. In some embodiments, the first QPs having the same target address as the to-be-scheduled out QP may be screened out on another link. For example, the first QPs having the same target address as the to-be-scheduled out QP are screened out on another link from an LA to an LC.

Illustratively, referring to FIG. 4A, assuming that the source server [IP: 1.1.1.1] is a source server outputting the traffic of the to-be-scheduled out QP, the target source LA may include an LA-1 and an LA-2.

In the embodiments of the present disclosure, the LC is a device connected to the LA, i.e., a switch located in a convergence layer. Illustratively, referring to FIG. 4A, the LC may include an LC-1 and an LC-2.

The first QPs involved in this embodiment of the present disclosure includes the to-be-scheduled out QP. Illustratively, a QP \textcircled{1} is a to-be-scheduled out QP, and QPs having the same target address as the QP \textcircled{1} include: a QP \textcircled{2}, a QP \textcircled{3}, and a QP \textcircled{4}. Then, the first QPs include: the QP \textcircled{1}, the QP \textcircled{2}, the QP \textcircled{3}, and the QP \textcircled{4}.

Operation 32: Determine a sum of traffic of the first QPs as total forwarding traffic.

The traffic of the first QPs involved in this embodiment of the present disclosure may include, but is not limited to, historical traffic, real-time traffic, and traffic obtained by mapping the historical traffic and the real-time traffic.

An implementation of determining the total forwarding traffic is not specifically limited in this embodiment of the present disclosure. In one embodiment, the real-time traffic of the first QPs may be added, and a sum of the real-time traffic is determined as the total forwarding traffic. In one embodiment, the historical traffic of the first QPs may be added, and a sum of the historical traffic is determined as the total forwarding traffic. In one embodiment, traffic obtained by performing real-time weighted summation on the historical traffic of the first QPs and the real-time traffic of the first QPs may be determined as the total forwarding traffic.

The embodiments of the present disclosure further provide an implementation of determining the target traffic-forwarding path. Referring to FIG. 3C, operation 103 shown in FIG. 3A may be implemented by performing operation 1031, which is described below in detail.

Operation 1031: Determine, based on the total forwarding traffic and the traffic of the links in the network, the target traffic-forwarding path configured for forwarding the traffic of the to-be-scheduled out QP.

The number of target traffic-forwarding paths configured for forwarding the traffic of the to-be-scheduled out QP is not specifically limited in this embodiment of the present disclosure. In one embodiment, one target traffic-forwarding path may be obtained, and subsequently, the traffic of the to-be-scheduled out QP may be forwarded based on the target traffic-forwarding path.

In one embodiment, a plurality of target traffic-forwarding paths may be obtained, and subsequently, one target traffic-forwarding path configured for forwarding the traffic of the to-be-scheduled out QP is selected from the plurality of target traffic-forwarding paths.

FIG. 3D shows that operation 1031 in FIG. 3C may be implemented by performing operation 10311 and operation 10312, which is described below in detail.

Operation 10311: Screen, based on load rates of a plurality of candidate links from an LA to the LC in the network, the plurality of candidate links to obtain a candidate link set.

The candidate link set includes at least one candidate link.

The candidate link involved in this embodiment of the present disclosure may be understood as a link between a source LA and an LC in a network. A source server to which the source LA of the candidate link is connected is a source server corresponding to the to-be-scheduled out QP so that the target traffic-forwarding path subsequently generated based on the candidate link may forward the traffic of the to-be-scheduled out QP.

The embodiments of the present disclosure further provide an implementation of determining the candidate link set, which may refer to FIG. 3E. Operation 10311 shown in FIG. 3D may be implemented by performing operation 103111 or operation 103112, which is described below in detail.

Operation 103111: Determine, when a load rate of any candidate link is less than a load rate threshold, a set formed by the candidate link as the candidate link set.

The load rate of the candidate link involved in operation 103111 is not specifically limited in this embodiment of the present disclosure.

In one embodiment, the load rate of the candidate link may include a real-time load rate of the candidate link. The real-time load rate may represent a real-time load status of a candidate link. A set formed by candidate links whose real-time load rates are less than the load rate threshold is determined as a candidate link set to ensure that all candidate links in the candidate link set are real-time low-load links. Since all candidate links in the candidate link set are real-time low-load links, load balancing of the network may be realized by forwarding the traffic of the to-be-scheduled out QP using the real-time low-load links.

In one embodiment, the load rate of the candidate link may include a historical load rate of the candidate link. The historical load rate may represent a stable and accurate load status of a candidate link. A set formed by candidate links whose historical load rates are less than the load rate threshold is determined as a candidate link set to ensure that all candidate links in the candidate link set are low-load links. Since all candidate links in the candidate link set are real-time low-load links, load balancing of the network may be realized by forwarding the traffic of the to-be-scheduled out QP using the real-time low-load links.

In one embodiment, the load rate of the candidate link may include a load rate obtained by mapping the historical load rate and the real-time load rate. The mapped load rate may accurately represent a load status of a candidate link with reference to the real-time load rate and the historical load rate. A set formed by candidate links whose mapped load rates are less than the load rate threshold is determined as a candidate link set to ensure that all candidate links in the candidate link set are low-load links. Since all candidate links in the candidate link set are real-time low-load links, load balancing of the network may be realized by forwarding the traffic of the to-be-scheduled out QP using the real-time low-load links.

The mapped load rate is not specifically limited in this embodiment of the present disclosure. Illustratively, the mapped load rate may be a load rate obtained by linearly combining the historical load rate and the real-time load rate. Illustratively, the mapped load rate may be a load rate obtained by performing weighted average on the historical load rate and the real-time load rate.

The embodiments of the present disclosure further provide an implementation of mapping the historical load rate and the real-time load rate. For example, the load rate obtained by mapping the historical load rate and the real-time load rate is determined in the following manner: performing, when the historical load rate is less than a first load rate threshold and the real-time load rate is less than a second load rate threshold, weighted summation on the historical load rate and the real-time load rate to obtain the load rate obtained by mapping the historical load rate and the real-time load rate. The values of the first load rate threshold and the second load rate threshold are not specifically limited in this embodiment of the present disclosure. Illustratively, the first load rate threshold may be 30%, and the second load rate threshold may be 50%.

In this implementation, weighted summation is performed on the historical load rate and the real-time load rate to obtain the load rate obtained by mapping the historical load rate and the real-time load rate. The mapped load rate may accurately represent a load status of a candidate link. A set formed by candidate links whose mapped load rates are less than the load rate threshold is determined as a candidate link set to ensure that all candidate links in the candidate link set are low-load links. Since all candidate links in the candidate link set are real-time low-load links, load balancing of the network may be realized by forwarding the traffic of the to-be-scheduled out QP using the real-time low-load links.

The value of the load rate threshold in operation 103111 is not specifically limited in this embodiment of the present disclosure. The load rate threshold may be set according to actual application. In some embodiments, the load rate threshold may be a constant value. Illustratively, the load rate threshold may be 30%, 50%, or the like, or may be a dynamic value adjusted according to requirements. In some embodiments, the load rate threshold may be a variable. Illustratively, the load rate threshold may be determined according to the total forwarding traffic. Illustratively, the total forwarding traffic is inversely proportional to the load rate. A larger total forwarding traffic indicates a smaller load rate threshold to ensure that the candidate links in the candidate link set may carry the total forwarding traffic.

In this implementation, a set formed by any candidate link whose load rate is less than the load rate threshold is determined as a candidate link set to ensure that the candidate link in the candidate link set may carry the total forwarding traffic.

Operation 103112: Sort the plurality of candidate links in ascending order based on the load rates of the plurality of candidate links, and determine a set of some candidate links sorted top in a sorting result as the candidate link set.

The load rate includes one of the following: a historical load rate in a plurality of sampling periods, a real-time load rate, and a load rate obtained by mapping the historical load rate and the real-time load rate. In this implementation, the load rates of the plurality of candidate links are sorted in ascending order, and a set of some candidate links sorted top is determined as the candidate link set. In this implementation, some candidate links sorted top may be understood as some candidate links with low load rates.

In this implementation, the candidate link set includes some candidate links with low load rates, and load balancing may be realized by forwarding the traffic using the target traffic-forwarding path obtained based on these candidate links.

In this embodiment of the present disclosure, several implementations of determining the candidate link set are illustratively introduced, and the foregoing implementations do not constitute a specific limitation. In an actual application process, the candidate link set may be determined using the foregoing manner or another manner.

Following operation 10311, in operation 10312, based on the total forwarding traffic and the candidate link set, the target traffic-forwarding path configured for forwarding the traffic of the to-be-scheduled out QP is determined.

In this implementation, the total forwarding traffic is considered in the process of determining the target traffic-forwarding path to ensure that the selected (determined) target traffic-forwarding path may carry the total forwarding traffic.

The embodiments of the present disclosure further provide an implementation of determining the changed route of the to-be-scheduled out QP. FIG. 3F shows that iterative processing may be performed in operation 10312 in FIG. 3C. The iterative processing may be implemented by performing operation 103121 to operation 103123, which is described below in detail.

Operation 103121: Select a target candidate link from the at least one candidate link included in the candidate link set.

A manner of selecting the target candidate link is not specifically limited in this embodiment of the present disclosure. In one embodiment, at least one candidate link with the lowest load rate may be selected from the candidate link set as the target candidate link. In one embodiment, a candidate link may be randomly selected from the candidate link set as the target candidate link.

When remaining bandwidth of any link in downstream links of the target candidate link cannot carry the total forwarding traffic, the target candidate link needs to be redetermined. The embodiments of the present disclosure further provide an implementation of determining the candidate link. After operation 103121, operation 103122a may be performed, which is described below in detail.

Operation 103122a: Remove, when remaining bandwidth of any link in the upstream links including the target candidate link is incapable of carrying the total forwarding traffic or remaining bandwidth of any link in the downstream links of the target candidate link is incapable of carrying the total forwarding traffic, the target candidate link from the candidate link set to obtain a new candidate link set.

In this embodiment of the present disclosure, the remaining bandwidth may be converted into the traffic through a conversion relationship between the bandwidth and the traffic, and then the traffic converted from the bandwidth is compared with the total forwarding traffic. When the traffic converted from the bandwidth is greater than or equal to the total forwarding traffic, the remaining bandwidth can carry the total forwarding traffic. When the traffic converted from the bandwidth is less than the total forwarding traffic, the remaining bandwidth cannot carry the total forwarding traffic.

In this embodiment of the present disclosure, the new candidate link set is configured for further iteration, that is, operation 103121 is continued to be performed based on the new candidate link set. When the remaining bandwidth of any link in the downstream links cannot carry the total forwarding traffic, it is determined that the downstream links cannot carry the total forwarding traffic. In this case, a target candidate link is reselected from the candidate link set.

The manner of selecting the target candidate link is described below with reference to FIG. 4A. The candidate link set is [LA-1=>LC-2, LA-1=>LC-3, LA-1=>LC-4]. Downstream links of LA-1=>LC-2 (target candidate link) include: LC-2=>LA-3 and LC-2=>LA-4. If remaining bandwidth of LC-2=>LA-3 and LC-2=>LA-4 cannot carry the total forwarding traffic, LA-1=>LC-2 is removed from [LA-1=>LC-2, LA-1=>LC-3, LA-1=>LC-4] (candidate link set) to obtain [LA-1=>LC-3, LA-1=>LC-4] (new candidate link set). Then, the target candidate link is selected from [LA-1=>LC-3, LA-1=>LC-4].

In this embodiment of the present disclosure, if it is determined that the remaining bandwidth of any link in the upstream links including the target candidate link cannot carry the total forwarding traffic or the remaining bandwidth of any link in the downstream links of the target candidate link cannot carry the total forwarding traffic, another candidate link is selected from the previously established candidate link set as the target candidate link. In the process of selecting the target candidate link again, the process of determining the candidate link is omitted, thereby shortening the time spent in determining the target candidate link to some extent, and ensuring the high efficiency of traffic scheduling.

Operation 103122b: Determine, when remaining bandwidth of each link in upstream links including the target candidate link is capable of carrying the total forwarding traffic and remaining bandwidth of each link in downstream links of the target candidate link is capable of carrying the total forwarding traffic, a path formed based on the target candidate link and the downstream links as the target traffic-forwarding path.

In this embodiment of the present disclosure, whether the remaining bandwidth of each link in the upstream links including the target candidate link can carry the total forwarding traffic is first determined. When the remaining bandwidth of each link in the upstream links including the target candidate link can carry the total forwarding traffic, whether the remaining bandwidth of each link in the downstream links can carry the total forwarding traffic is determined. The upstream link and the downstream link are described below with reference to specific accompanying drawings.

When the target candidate link is located in a Layer 2 architecture, the upstream link includes the target candidate link. The downstream links include a link from the LC to a destination LA. Illustratively, referring to FIG. 4A, the upstream link is LA-1=>LC-1 (target candidate link), and the downstream links may include LC-1=>LA-3 and LC-1=>LA-4. In FIG. 4A, the LA-3 and the LA-4 are connected to the destination server. The LA-3 and the LA-4 are destination LAs.

When the target candidate link is located in a Layer 3 architecture, the upstream links include: the target candidate link and a link from the LC to a Super-LC through which the to-be-scheduled out QP passes. The downstream links include: a link from the Super-LC to a downstream LC and a link from the downstream LC to the destination LA. Illustratively, referring to FIG. 4B, the upstream links include: LA-1=>LC-1 (target candidate link), LC-1=>Super-LC-1, and LC-1 to Super-LC-2. Downstream links of LA-1=>LC-1 may include: Super-LC-1=>LC-2, Super-LC-1=>LC-3, Super-LC-1=>LC-4, Super-LC-2=>LC-2, Super-LC-2=>LC-3, Super-LC-2=>LC-4, LC-2=>LA-3, LC-2=>LA-4, LC-3=>LA-3, LC-3=>LA-4, LC-4=>LA-3, and LC-4=>LA-4.

A process of generating the target traffic-forwarding path is described below with reference to FIG. 4A. Downstream links of LA-1=>LC-2 (target candidate link) include: LC-2=>LA-3 and LC-2=>LA-4. If remaining bandwidth of LC-2=>LA-4 can carry the total forwarding traffic, it is determined that LA-1=>LC-2=>LA-4 is the target traffic-forwarding path.

A process of generating the target traffic-forwarding path is described below with reference to FIG. 4B. Downstream links of LA-1=>LC-1 (target candidate link) includes LC-1 to Super-LC-1. If remaining bandwidth from LC-1 to Super-LC-1 can carry the total forwarding traffic, whether remaining bandwidth of Super-LC-1=>LC-2, Super-LC-1=>LC-3, and Super-LC-1=>LC-4 can carry the total forwarding traffic is determined, respectively. If the remaining bandwidth of Super-LC-1=>LC-2 can carry the total forwarding traffic, whether remaining bandwidth of LC-2=>LA-3 and LC-2=>LA-4 can carry the total forwarding traffic is determined, respectively. If the remaining bandwidth of LC-2=>LA-4 can carry the total forwarding traffic, A path: LA-1=>LC-1=>Super-LC-1=>LC-2=>LA-4 is determined as the target traffic-forwarding path.

Operation 103123: End an iteration when an iteration stop condition is met.

In one embodiment, the iteration stop condition includes: determining the target traffic-forwarding path.

In this implementation, when the target traffic-forwarding path is determined, whether another candidate link in the candidate link set can carry the total forwarding traffic is not determined, thereby reducing the data processing amount of the server to some extent, and ensuring the high efficiency of traffic scheduling.

In one embodiment, the iteration stop condition includes: the candidate link set being null.

In this implementation, for each candidate link in the candidate link set, whether downstream links of the candidate link can carry the total forwarding traffic is determined, and then a plurality of target traffic-forwarding paths may be obtained. The plurality of target traffic-forwarding paths may all be configured for forwarding the traffic of the to-be-scheduled out QP.

In one embodiment, after the target traffic-forwarding path is determined, a target candidate link is selected again from the candidate link set, and then whether remaining bandwidth of the selected candidate link can carry the total forwarding traffic is determined. In one embodiment, whether the remaining bandwidth of all candidate links in the candidate link set can carry the total forwarding traffic may be synchronously determined. Through the foregoing two implementations, a plurality of target traffic-forwarding paths may be obtained.

In an actual application process, there is a case, that is, the traffic of the to-be-scheduled out QP cannot be forwarded (outputted) through the target traffic-forwarding path. To ensure successful traffic scheduling, the embodiments of the present disclosure further provide an implementation of replacing the target traffic-forwarding path. When there are a plurality of target traffic-forwarding paths and the traffic of the to-be-scheduled out QP is incapable of being outputted through a sampled target traffic-forwarding path, the traffic of the to-be-scheduled out QP is outputted based on another target traffic-forwarding path. The another target traffic-forwarding path is a target traffic-forwarding path except the sampled target traffic-forwarding path in the plurality of target traffic-forwarding paths. In this implementation, in the process of selecting the target candidate link again, the process of determining the target traffic-forwarding path is omitted, thereby shortening the time spent in determining the target traffic-forwarding path to some extent, and ensuring the high efficiency of traffic scheduling.

Operation 104: Determine a changed route of the to-be-scheduled out QP based on a target address of the to-be-scheduled out QP and the target traffic-forwarding path.

In this embodiment of the present disclosure, the changed route includes: a destination address, an egress port, and next hop information. The egress port and the next hop information are calculated based on the target traffic-forwarding path, and a calculation process thereof is related to a network architecture, which is described in detail below.

Operation 105: Deliver the changed route to a target source LA of the to-be-scheduled out QP, the target source LA being configured to output, based on the changed route, the traffic of the to-be-scheduled out QP through the target traffic-forwarding path.

In some embodiments, the changed route may be delivered to another device in the network, for example, a source LC of the to-be-scheduled out QP, or a Super-LC (i.e., a switch located in a core layer) of the to-be-scheduled out QP.

An embodiment of recovering the route is provided. FIG. 3G shows that after operation 105 in FIG. 3A, operation 106a to operation 107a may be performed, which is described below in detail.

Operation 106a: Collect statistics on duration of the traffic of the to-be-scheduled out QP passing through the target traffic-forwarding path.

In this embodiment of the present disclosure, an end point of the duration of the traffic of the to-be-scheduled out QP passing through the target traffic-forwarding path is a current time. A starting point of the duration of the traffic of the to-be-scheduled out QP passing through the target traffic-forwarding path may include any one of the following times: a time of generating the changed route, a time of delivering the changed route, a time of forwarding the traffic, a time of determining network congestion, and a time of determining the target traffic-forwarding path.

Operation 107a: Deliver, in response to the duration reaching a preset time, a recovery instruction to the target source LA of the to-be-scheduled out QP.

In this embodiment of the present disclosure, the recovery instruction is configured for instructing the target source LA to output the traffic of the to-be-scheduled out QP based on a recovered congested link.

The preset time may be set according to requirements. In one embodiment, the preset time may be determined based on the starting point of the duration of the traffic of the to-be-scheduled out QP passing through the target traffic-forwarding path. In one embodiment, statistics on duration required for recovering from network congestion may be collected according to historical data, and then the preset time is determined based on the duration. Illustratively, according to a statistical result of the historical data, the duration required for recovering from network congestion is three minutes, and the preset time may be set to three minutes.

In this implementation, the duration of the traffic of the to-be-scheduled out QP passing through the target traffic-forwarding path reaches the preset time, and the target source LA outputs the traffic of the to-be-scheduled out QP based on the recovered congested link, thereby realizing load balancing of the entire network.

The embodiments of the present disclosure further provide an implementation of recovering the route. FIG. 3H shows that after operation 105 shown in FIG. 3A, operation 106b to operation 107b may be performed, which is described below in detail.

Operation 106b: Detect a congestion degree of the congested link.

This embodiment of the present disclosure is not limited to a manner of detecting the congestion degree. For example, the congestion degree of the congested link may be determined through an ECN count of the link. A higher ECN count indicates a higher congestion degree of the congested link. The congestion degree of the congested link may alternatively be determined according to the load status of the congested link. Higher load of the congested link indicates a higher congestion degree of the congested link.

Operation 107b: Deliver, in response to the congestion degree representing that the congested link is recovered to be normal, the recovery instruction to the target source LA of the to-be-scheduled out QP.

For example, when a detected congestion degree is less than a congestion degree threshold, the congested link is recovered to be normal and is no longer congested. When the detected congestion degree is greater than or equal to the congestion degree threshold, the congested link is still congested. The congestion degree threshold may be a preset threshold and may be adjusted according to requirements.

In this implementation, after the congested link is recovered to be normal, the target source LA outputs the traffic of the to-be-scheduled out QP based on the recovered congested link, thereby realizing load balancing of the entire network.

Exemplary application of the embodiments of the present disclosure in an actual application scene will be described below.

The embodiments of the present disclosure may be applied to various networks, such as a game network and a cloud computing network. A training network for a large model is used as an example below.

Duration of training tasks of an AI large model is long, usually ranging from dozens of hours to dozens of days. During the training process of the large model, instantaneous traffic of the GPU is large, sometimes as much as 100 gigabytes (Gb)/second, with short duration. Compared with other business traffic, the AI large model has very significant features. (1) Burstiness: the training tasks are calculated in parallel on different GPUs, and communication is usually performed only after a plurality of calculation results are completed. Consequently, the network is idle most of the time, and a large amount of data needs to be transmitted in a short time. Using a port with 200 gigabits (G) per second as an example, the peak traffic of the port may reach 190 G per second, with a duration of 3 seconds. Therefore, the traffic distribution of the AI large model is imbalanced and has burstiness. (2) Periodicity: all AI training tasks have a fixed iteration period, that is, a traffic transmission process has periodicity. In this embodiment of the present disclosure, one route calculation may be applied to a plurality of model training periods. Training tasks of a neural network model have strict requirements on the network, and a general data communications network (DCN) cannot satisfy the requirements of neural network model training on the network.

The requirements of neural network model training on the network may be satisfied using an RDMA-matched IB network solution. The cost of an RDMA-matched IB network is very high. Therefore, currently, a mainstream DCN transmits data based on RDMA. However, RDMA-based data transmission easily causes the problem of network congestion in an application scene of the neural network model.

An objective of the embodiments of the present disclosure is to relieve the problem of network congestion in the application scene of the neural network model.

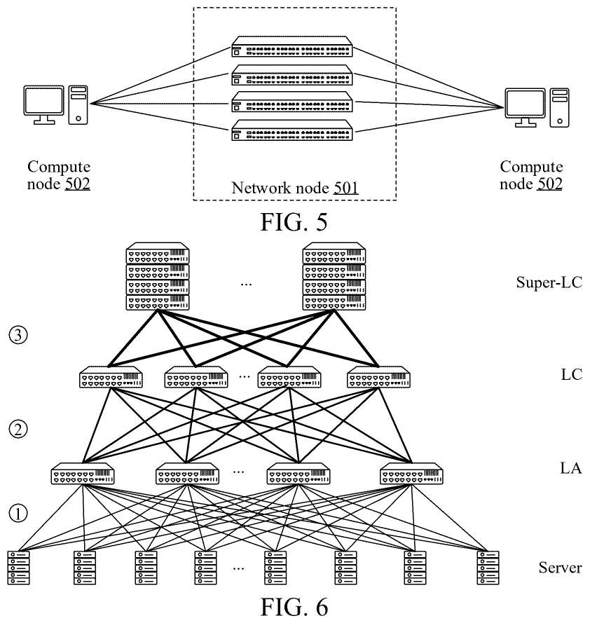

Referring to FIG. 5, infrastructure in the AI large model includes a large number of compute nodes (for example, HPC servers) and a series of network nodes (interaction machines). The network node 501 may include, but is not limited to, a switch in an IB series, an Ethernet switch, and the like. The compute node 502 is generally a GPU server with a plurality of smart network interface cards. The smart network interface card may include a smart network interface card for RDMA-based data transmission.

The AI large model may be implemented through a network such as an HPC network and a DCN. Network architectures of the HPC network and the DCN are classic fat-tree architectures.

FIG. 6 shows a fat-tree network architecture according to an embodiment of the present disclosure. A typical characteristic of the fat-tree network architecture is that a convergence ratio of the entire network is 1:1. In FIG. 6, bandwidth between a network port of the server and a port of a switch (LA) (corresponding to a line in \textcircled{1}) is 100 G. Then, bandwidth between the port of the LA switch and a port of an LC switch (corresponding to a line in \textcircled{2}) is 200 G, and bandwidth between the port of the LC switch and a port of a Super-LC switch (corresponding to a line in \textcircled{3}) is 400 G. Therefore, using a calculation method of “total number of lines * line bandwidth”, it can be easily found that a total egress bandwidth of the server, a total egress bandwidth of the LA, and a total egress bandwidth of the LC are the same.

A disaster tolerance capability of the fat-tree network architecture is related to the link bandwidth utilization. Assuming that the bandwidth utilization of the links in the network is maintained at approximately 50%, if approximately half of the links or devices fail, the network can still run normally without packet loss after route convergence. Therefore, the fat-tree network architecture can be widely applied. The fat-tree network architecture is applicable to the HPC network and the DCN. A fat-tree network architecture in the HPC network is used as an example for description below.

Compared with the DCN, the HPC network usually maintains the bandwidth utilization between the server and the LA switch at 100%. In addition, to avoid a transmission speed reduction caused by a fault, the HPC network is designed to have particular redundant bandwidth between the LA and the LC, and between the LC and the Super-LC. Meanwhile, to avoid occurrence of a super elephant flow (a source IP, a destination IP, a protocol number, a source port number, and a destination port number are always the same) in the network, a plurality of pairs of QPs are usually established between the source (source server) and the destination (destination server) and evenly distributed to different links from LA to LC and LC to Super-LC.

The fat-tree network architecture in the HPC network mainly includes an HPC Layer 2 network architecture and an HPC Layer 3 network architecture. Congestion may occur in both of the foregoing two architectures, which are described separately below.

Congestion scene of HPC Layer 2 network architecture:

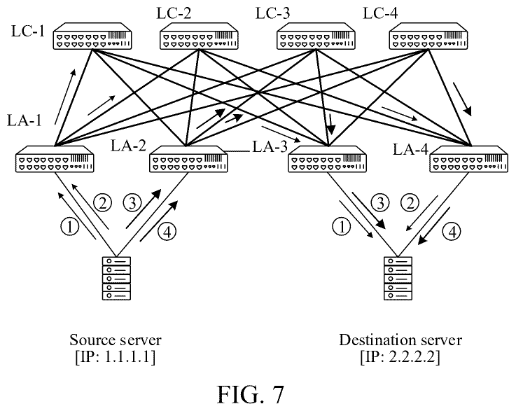

Illustratively, referring to FIG. 7, the HPC network provided in FIG. 7 includes load balancing of four QPs (\textcircled{1}, \textcircled{2}, \textcircled{3}, and \textcircled{4}) in the Layer 2 network architecture. First, it is assumed that a network interface card of the server is 100 G. There are four QPs (\textcircled{1}, \textcircled{2}, \textcircled{3}, and \textcircled{4}) between the source server 1.1.1.1 and the destination server 2.2.2.2 in total. In an initial stage, paths of the four QPs are different from each other, and initial path information of the four QPs is shown in Table 1.

TABLE 1
Initial path distribution and QP states of four
QPs of HPC Layer 2 network architecture

| | | | |
|---|---|---|---|
| QP number | Path | QP traffic | Note |

| | | |
|---|---|---|
| \textcircled{1} | LA-1 => LC-1 => LA-3 | 50 G |
| \textcircled{2} | LA-1 => LC-2 => LA-4 | 50 G |
| \textcircled{3} | LA-2 => LC-3 => LA-3 | 50 G |
| \textcircled{4} | LA-2 => LC-4 => LA-4 | 50 G |

As shown in Table 1, if no fault occurs, the initial path is optimal. However, a network fault is often unpredictable in the real world, although its probability is not high. Assuming that at time T, an upstream link LA-1=>LC-1 fails and causes a path of a QP numbered \textcircled{1} to become invalid, subsequently the switch LA-1 automatically completes route convergence (hash-based routing needs to be performed again) and brings the network back to a stable state. During this period, the path of the QP numbered \textcircled{1} changes as follows.

The original path is LA-1=>LC-1=>LA-3.

A new path is LA-1=>LC-2=>LA-4.

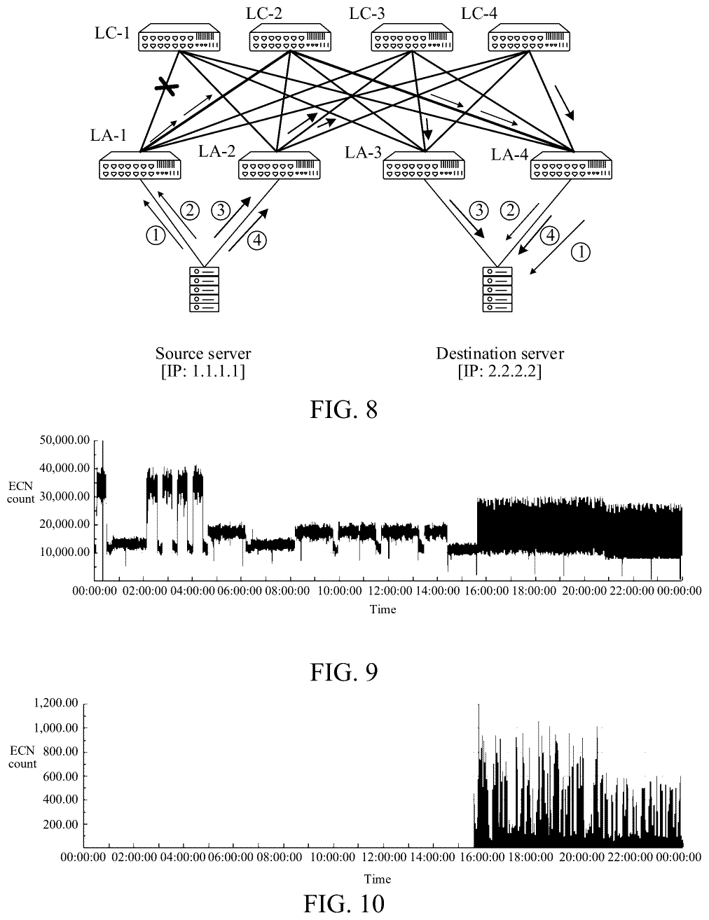

Herein, a new problem occurs. That is, the path of the QP numbered \textcircled{1} and a path of a QP numbered \textcircled{2} are completely the same. A worse result is that the number of QPs distributed on the 100 G link of LA-4=>destination server changes from two to three, as shown in FIG. 8. This also means that there are three QPs (\textcircled{1}, \textcircled{2}, and \textcircled{4}) to evenly divide the downstream 100 G bandwidth of LA-4 to the destination server. As a result, transmission rates of these QPs (\textcircled{1}, \textcircled{2}, and \textcircled{4}) all decrease from the current 50 G to approximately 33 G (the transmission delay on a business side will increase significantly). In this case, the distribution of the four QP paths in the network is shown in Table 2.

TABLE 2
States of four QPs after HPC Layer 2 network architecture LA =>
LC upstream link (LA-1 => LC-1) fails

| | | | |
|---|---|---|---|
| QP number | Path | QP traffic | Note |

| | | | |
|---|---|---|---|
| \textcircled{1} | LA-1 => LC-2 => LA-4 | 33.3 | G |
| \textcircled{2} | LA-1 => LC-2 => LA-4 | 33.3 | G |
| \textcircled{3} | LA-2 => LC-3 => LA-3 | 50 | G |
| \textcircled{4} | LA-2 => LC-4 => LA-4 | 33.3 | G |

In fact, once a link fault occurs in the network, other links may further be congested. In the HPC network, congestion is not manifested as prolonged high traffic levels, but as an instantaneous short burst.

FIG. 9 shows a daily traffic curve of a link of LA=>LC. It can be seen that the peak traffic is 42 Gb (physical port bandwidth of the switch being 200 G). It can be seen from FIG. 10 that an ECN count keeps high since the fault occurs. The ECN count may represent link congestion to some extent.

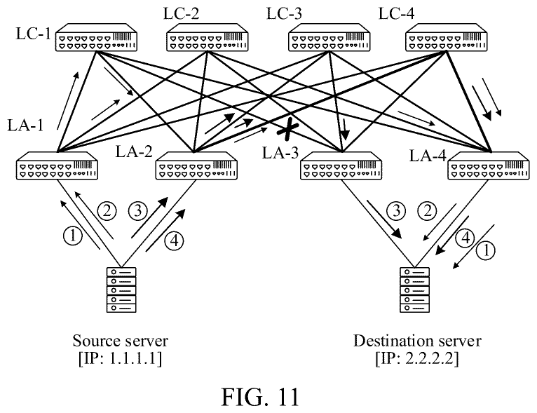

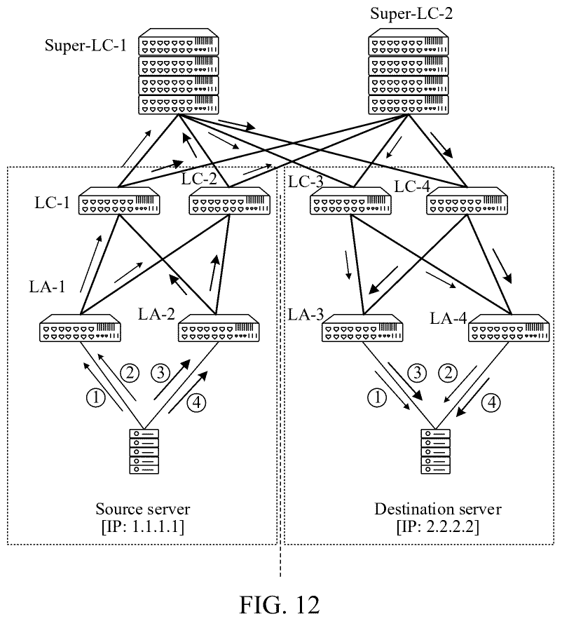

In addition to a fault scene of the LA=>LC upstream link, a congestion phenomenon may further occur in an LC=>LA downstream link. As shown in FIG. 11, the LC=>LA downstream link (LC-1=>LA-3) is congested. States of four QPs (\textcircled{1}, \textcircled{2}, \textcircled{3}, and \textcircled{4}) in the network are shown in Table 3. Traffic and ECN distribution of the congested link (LC-1=>LA-3) are similar to those of the upstream link (LA-1=>LC-1 in FIG. 10), and details are not described herein again.

TABLE 3
States of four QPs after HPC Layer 2 network architecture LC =>
LA downstream link (LC-1 => LA-3) fails

| QP | | QP | |
|---|---|---|---|
| number | Path | traffic | Note |
| \textcircled{1} | LA-1 => LC-1 => LA-2 => | 33.3 G | After the link from LC-1 |
| | LC-4 => LA-4 | | to LA-3 fails, traffic of |
| | | | the QP numbered \textcircled{1} is |
| | | | rerouted to LA-2. |
| \textcircled{2} | LA-1 => LC-2 => LA-4 | 33.3 G | |
| \textcircled{3} | LA-2 => LC-3 => LA-3 | 50 G | |
| \textcircled{4} | LA-2 => LC-4 => LA-4 | 33.3 G | |

Congestion scene of HPC Layer 3 network architecture:

When the size of a server cluster of the HPC network exceeds 4,096 network interface cards (4K cards), the Layer 2 network architecture cannot satisfy a network requirement of the business. In this case, the Layer 3 network architecture needs to be introduced.

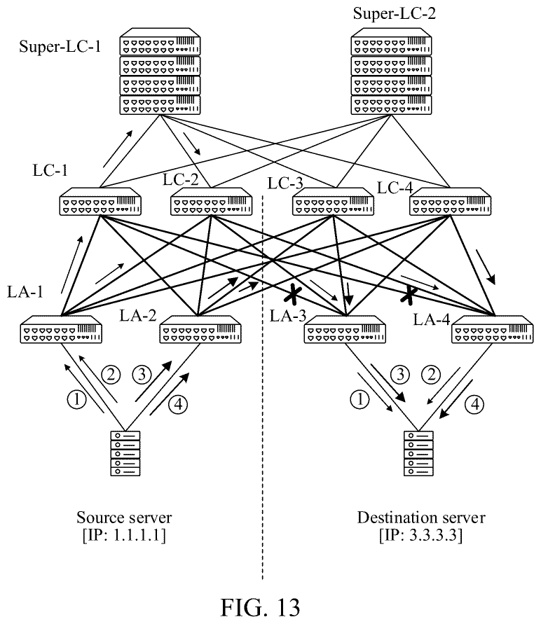

A difference between the Layer 3 network architecture and the Layer 2 network architecture lies in that the Layer 3 network architecture does not have a full-mesh connection between the LA and the LC. A concept of a rail is introduced in the Layer 3 network architecture. A rail is an independent Layer 2 network architecture topology. Different rails are interconnected through the Super-LC, that is, two cross-rail servers (the source server and the destination server) need to be interconnected through the Super-LC, as shown in FIG. 12.

Using FIG. 12 as an example, it is assumed that a network interface card of the server is 100 G. There are four QPs (\textcircled{1}, \textcircled{2}, \textcircled{3}, and \textcircled{4}) between the cross-rail source server 1.1.1.1 and destination server 2.2.2.2. In an initial stage, paths of the four QPs are different from each other, and path information is shown in Table 4.

TABLE 4
Initial path distribution of four QPs of Layer 3 network architecture

| | | | |
|---|---|---|---|
| QP | | QP | |
| number | Path | traffic | Note |

| | | |
|---|---|---|
| \textcircled{1} | LA-1 => LC-1 => Super-LC-1 => LC-3 => | 50 G |
| | LA-3 | |
| \textcircled{2} | LA-1 => LC-2 => Super-LC-2 => LC-3 => | 50 G |
| | LA-4 | |
| \textcircled{3} | LA-2 => LC-1 => Super-LC-2 => LC-4 => | 50 G |
| | LA-3 | |
| \textcircled{4} | LA-2 => LC-2 => Super-LC-1 => LC-4 => | 50 G |
| | LA-4 | |

In addition to that communication traffic between the cross-rail source server and destination server is rerouted to a third-layer device (Super-LC-1 and Super-LC-2), another in-rail fault scene may cause the traffic to reroute to the third-layer device (Super-LC-1 and Super-LC-2).

As shown in FIG. 13, LC-1=>LA-3 and LC-1=>LA-4 fail simultaneously. Both LA-3 and LA-4 cancel a BGP route to a destination server 3.3.3.3. In this case, LC-1 can only reach the destination server 3.3.3.3 via Super-LC-1 or Super-LC-2.

An implementation of rerouting after an LC to LA downstream link (LC-1=>LA-3) fails may refer to FIG. 13. The path of the QP numbered \textcircled{1} before and after the fault changes as follows.

The original path is LA-1=>LC-1=>LA-3.

A new path is LA-1=>LC-1=>Super-LC-1=>LC-2=>LA-3.

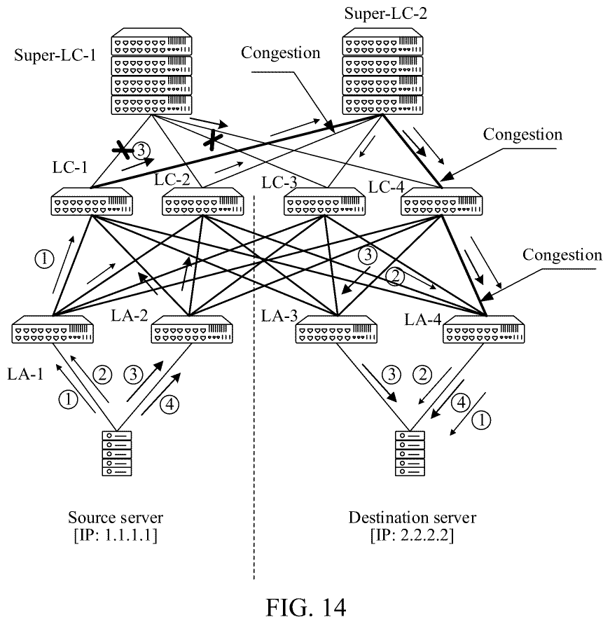

For the Layer 3 network architecture, a fault scene is similar to that of a Layer 2 traffic model. Assuming that a link from LC-1 to Super-LC-1 or a Super-LC-1=>LC-3 link through which the QP numbered \textcircled{1} in FIG. 12 passes fails, after the network completes automatic convergence, (LC-1=>Super-LC-2, Super-LC-2=>LC-4, and LC-4=>LA-4) link congestion may be caused. As shown in FIG. 14, in this case, four QPs in the network are shown in Table 5. Processes of fault convergence, congestion, and transmission speed reduction of business data are similar to those of the Layer 2 network architecture, and details are not described herein again.

TABLE 5
Initial path distribution of four QPs of Layer 3 network architecture

| QP | | QP | | |
|---|---|---|---|---|
| number | Path | traffic | | Note |
| \textcircled{1} | LA-1 => LC-1 => Super-LC- | 33.3 | G | Switch traffic |
| | 2 => LC-4 => LA-4 | | | from Super-LC-1 |
| | | | | to Super-LC-2 |
| \textcircled{2} | LA-1 => LC-2 => Super-LC- | 33.3 | G | |
| | 2 => LC-3 => LA-4 | | | |
| \textcircled{3} | LA-2 => LC-1 => Super-LC- | 50 | G | |
| | 2 => LC-4 => LA-3 | | | |
| \textcircled{4} | LA-2 => LC-2 => Super-LC- | 33.3 | G | |
| | 1 => LC-4 => LA-4 | | | |

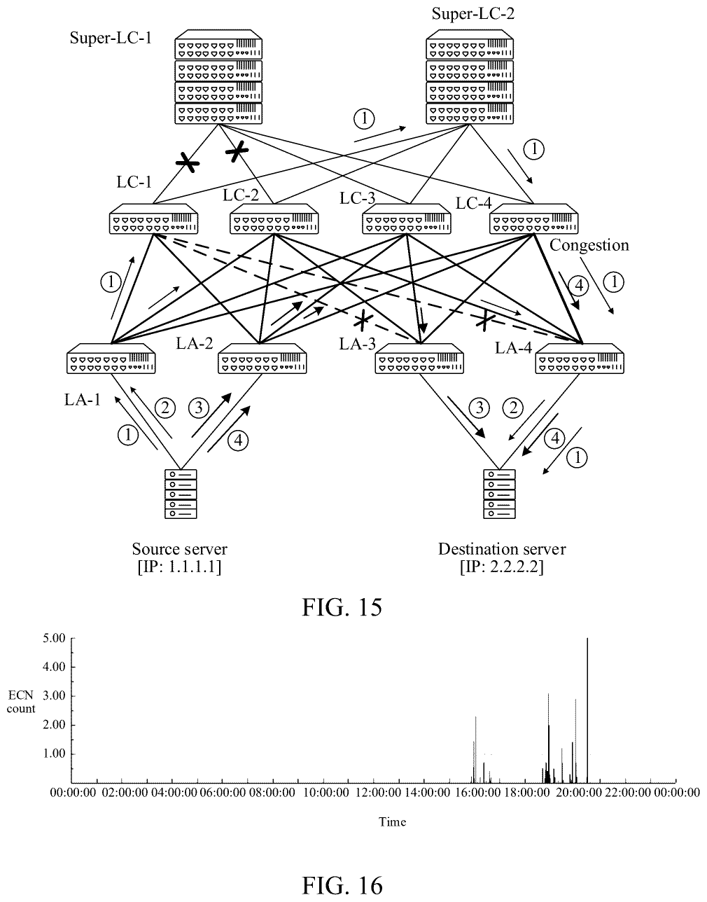

For a scene in which the traffic is rerouted to the third-layer device after downstream links from an LC=>all LAs in the rail fail, if a link between the LC and the Super-LC through which the QP passes continues to fail, after the network completes automatic convergence, other links may be congested, or even transmission speed reduction of business data may be caused. FIG. 15 shows a congestion status after an LC=>LA (LC-1=>LA-3, LC-1=>LA-4) link fails, traffic of the QP numbered \textcircled{1} reroutes three layers and converges after a secondary fault of an LC=>Super-LC (LC-1=>Super-LC-1, LC-2=>Super-LC-1) link. A specific process is not significantly different from that in another congestion scene, and details are not described again. The path of the QP numbered \textcircled{1} changes as follows.

The original path is LA-1=>LC-1=>Super-LC-1=>LC-3=>LA-3.

A new path is LA-1=>LC-1=>Super-LC-2=>LC-4=>LA-4.

It can also be seen from the foregoing that there QPs, i.e., \textcircled{1}, \textcircled{2}, and \textcircled{4}, evenly divide 100 G bandwidth of LA-4 to the destination server. As a result, transmission rates of the three QPs all decrease from 50 G to approximately 33.3 G, and the ECN of LC-4=>LA-4 greatly increases. That is, LC-4=>LA-4 is congested. When network congestion occurs, troubleshooting and fault localization can only rely on manual intervention, or else the network must be left to recover on its own. Manual troubleshooting, however, is time-consuming.

In this embodiment of the present disclosure, a 32-bit BGP route is introduced to an access layer switch (LA). In the foregoing manner, some traffic on the congested link is automatically scheduled to a low-load link, and a congestion clearance time is stabilized at about three minutes.

The embodiments of the present disclosure may be directly applied to a RoCE network of the AI large model, and the network quality is determined by observing a change trend of the ECN in the network. Generally, when the ECN count is less than 500, the business is basically imperceptible, and the AI training task is not affected. However, the network is usually configured with a lower (for example, 200 or 100) ECN count threshold, and then the network quality is observed. Once the ECN count is greater than a detection alarm threshold, an ECN alarm is generated. Although the AI large model has the characteristics of burstiness and periodicity, since the problem of network congestion can be resolved quickly in the embodiments of the present disclosure, the training process of the AI large model is not affected.

Regardless of a small and medium-scale GPU server cluster with 4K cards or less, or a large/ultra-large-scale GPU server cluster with more than 4K cards, when problems such as increased communication delay, speed reduction, or even frame freezing occur, if the problem is related to the network, it is usually manifested on the network that an ECN count on a link increases sharply and remains high, as shown in FIG. 10. In a normal situation, when the QP traffic on the link is relatively load-balanced, the ECN count is very low. FIG. 16 shows a daily ECN statistical count curve of a port.

The ECN count on the congested link is a core quantization indicator for determining network congestion in this embodiment of the present disclosure. Since the ECN count directly represents the network quality, the ECN count is further indirectly fed back to the GPU server.

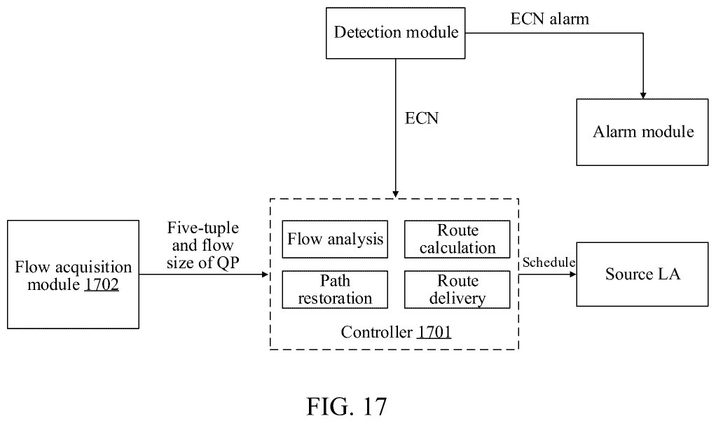

Hereinafter, with reference to FIG. 17, a scheduling method for managing network congestion according to an embodiment of the present disclosure is described.

When a detection module (detection platform) finds that a link is congested, that is, an ECN count on the link reaches a configured ECN count threshold (flow analysis), the detection module generates an ECN alarm to an alarm module and notifies a control module to perform processing, that is, perform the scheduling method for managing network congestion provided in the embodiments of the present disclosure.

A specific processing process is as follows.

First, a controller 1701 (control module) pulls five-tuple information of all QPs on the congested link from a flow acquisition module 1702 (sflow), sorts average traffic in the latest six sampling periods, and finds a QP (which may be represented as QP-A in this embodiment of the present disclosure) with the largest traffic.

Then, the controller 1701 obtains a network forwarding path (the network forwarding path is a complete path from a source LA switch to a destination LA switch) of the QP-A with reference to information on other links acquired by the flow acquisition module and finds a source LA where the QP-A is located.

Next, based on a destination IP of the QP-A, a 32-bit route is generated and delivered to a target source LA. An egress port and next hop information of the route need to be calculated, and a calculation process and route content are related to a network architecture, which are described in detail below.

The source LA is an LA connected to the source server, and the target source LA is a source LA of a congested QP.

Once the route is delivered to the source LA, the traffic of the QP-A bypasses the congested link. After a period of time, the detection platform receives an ECN alarm recovery (path restoration).

A route calculation method is described below through the Layer 2 network architecture and the Layer 3 network architecture.

A route calculation method in the Layer 2 network architecture is as follows.

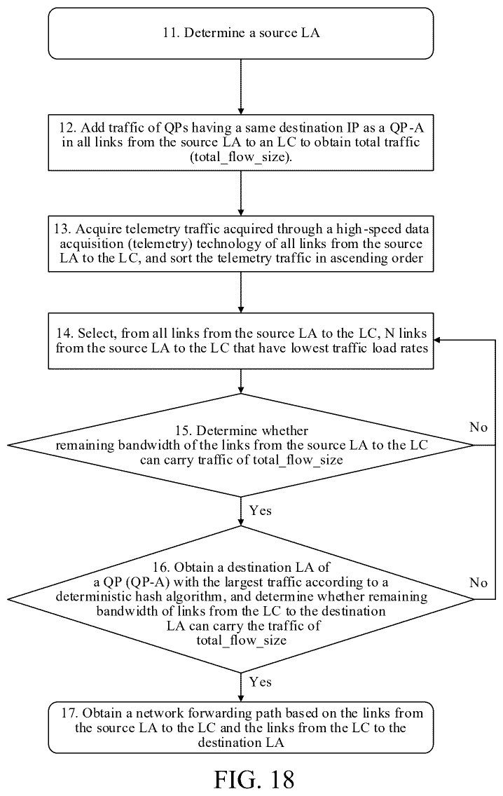

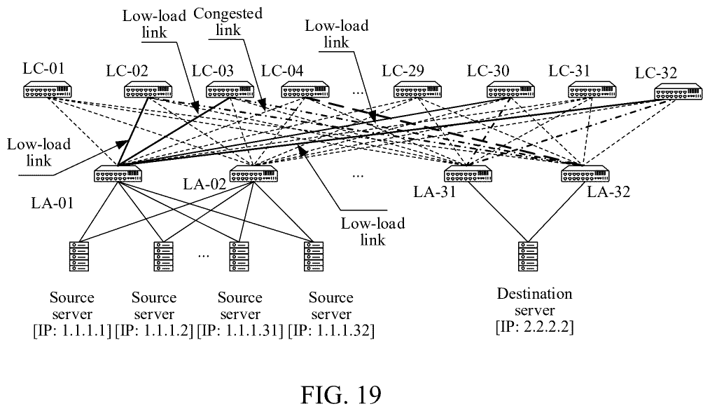

After four low-load links are found on the source LA, the LC is determined. In this process, a new path (network forwarding path) of the QP may be determined through a deterministic hash algorithm only once. Specific descriptions are provided below with reference to FIG. 18 and FIG. 19.

Operation 11: Determine a source LA.

The source LA is an LA connected to the source server.

Operation 12: Add traffic of QPs having a same destination IP as a QP-A in all

links from the source LA to an LC to obtain total traffic (total_flow_size).

Operation 13: Acquire traffic acquired through a high-speed data acquisition (telemetry) technology (telemetry traffic) of all links from the source LA to the LC, and sort the traffic in ascending order.

Operation 14: Select, from all links from the source LA to the LC, N links (for example, N=4) from the source LA to the LC that have lowest traffic load rates.

Referring to FIG. 19, a link from LA-01 to LC-04 is a congested link. Four links from the source LA (LA-01) to the LC having the lowest load rates are LA-01=>LC-02, LA-01=>LC-03, LA-01=>LC-30, and LA-01=>LC-32, respectively.

Operation 15: Determine whether remaining bandwidth of the links from the source LA to the LC can carry traffic of total_flow_size. If the remaining bandwidth of the links from the LA to the LC can carry the traffic of total_flow_size, operation 16 is performed. Otherwise, operation 14 is performed.

Operation 16: Obtain a destination LA of the QP-A according to the deterministic hash algorithm, and determine whether remaining bandwidth of links from the LC to the destination LA can carry the traffic of total_flow_size. If the remaining bandwidth of the links from the LC to the destination LA can carry the traffic of total_flow_size, operation 17 is performed.

The destination LA is an LA connected to the destination server. The deterministic hash algorithm is an algorithm that can generate a fixed output hash value and can always obtain the same hash result when same input data is given. Such an algorithm is very useful in a distributed system, particularly for data storage and distribution, thereby ensuring data integrity and consistency. The deterministic hashing can be configured for ensuring that the location of data in a distributed storage system is fixed so that when the data needs to be accessed, a server storing the data may be quickly located. During implementation of deterministic hashing, a particular hash function may be adopted, and the consistency of outputted hash values is ensured through some methods (for example, adding a fixed prefix or suffix). In this way, even for different data, hash values obtained after hashing are arranged in a specific manner, to facilitate searching and locating in the distributed system.

Operation 17: Obtain a network forwarding path based on the links from the source LA to the LC and the links from the LC to the destination LA.

A route calculation method in the Layer 3 network architecture is as follows.

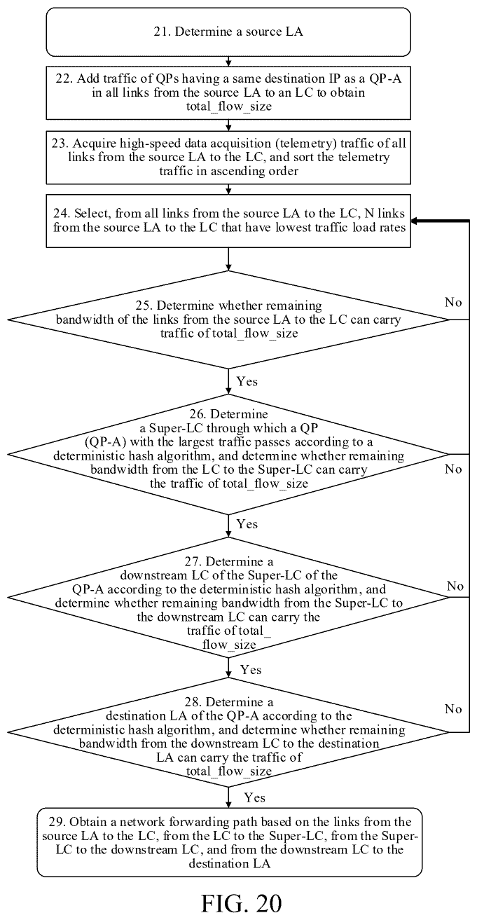

The general idea is similar to that of the Layer 2 network architecture. However, a new path of the QP may be determined using the deterministic hash algorithm multiple times. Specific descriptions are provided below with reference to FIG. 20.

Operation 21: Determine a source LA.

Operation 22: Add traffic of QPs having a same destination IP as a QP-A in all links from the source LA to an LC to obtain total_flow_size.

Operation 23: Acquire telemetry traffic of all links from the source LA to the LC, and sort the telemetry traffic in ascending order.

Operation 24: Select, from all links from the source LA to the LC, N links (for example, N=4) from the source LA to the LC that have lowest traffic load rates.

Operation 25: Determine whether remaining bandwidth of the links from the source LA to the LC can carry traffic of total_flow_size. If the remaining bandwidth of the links from the LA to the LC can carry the traffic of total_flow_size, operation 26 is performed.

Operation 26: Obtain, according to the deterministic hash algorithm, a Super-LC through which the QP-A passes, and determine whether remaining bandwidth from the LC to the Super-LC can carry the traffic of total_flow_size. If the remaining bandwidth from the LC to the Super-LC can carry the traffic of total_flow_size, operation 27 is performed. Otherwise, operation 24 is performed.

Operation 27: Determine a downstream LC of the Super-LC of the QP-A according to the deterministic hash algorithm, and determine whether remaining bandwidth from the Super-LC to the downstream LC can carry the traffic of total_flow_size. If the remaining bandwidth from the Super-LC to the downstream LC can carry the traffic of total_flow_size, operation 28 is performed. Otherwise, operation 24 is performed.

Operation 28: Determine a destination LA of the QP-A according to the deterministic hash algorithm, and determine whether remaining bandwidth from the downstream LC to the destination LA can carry the traffic of total_flow_size. If the remaining bandwidth from the downstream LC to the destination LA can carry the traffic of total_flow_size, operation 29 is performed. Otherwise, operation 24 is performed.

Operation 29: Obtain a network forwarding path based on the links from the source LA to the LC, from the LC to the Super-LC, from the Super-LC to the downstream LC, and from the downstream LC to the destination LA.

For routes delivered to the destination LA, when there is no congestion, routes advertised by the BGP devices in the network are all/26 aggregated routes. Using the destination server 2.2.2.2 as an example, traffic to the LA-01 uses 2.2.2.0/24.

After network congestion occurs, the controller may write a BGP route to the source LA. The BGP route has a destination address of 2.2.2.2, a mask length of 32, and a path (as-path) attribute and a transparent transmission (community) attribute inherited from the parent route 2.2.2.0/24 of the BGP route. Next hop information (nexthop) is selected from a subset of the parent route. The next hop of the parent route is IP addresses of all LC interconnecting ports that normally establish BGP neighbors with the LAN.

To avoid routing loops and traffic black holes, the route written by the controller may further carry a network no-advertise attribute to prohibit a device from issuing the route to another device (peer). Meanwhile, when the parent route 2.2.2.0/24 is canceled or its attribute changes, the controller synchronously updates a child route 2.2.2.2/32.

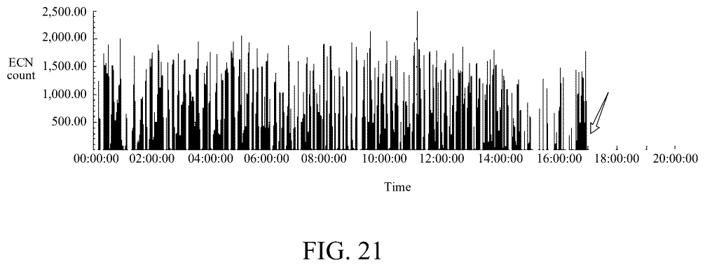

After the scheduling method provided in the embodiments of the present disclosure is adopted, an ECN count of a network may refer to FIG. 21. A position indicated by the arrow is the time when the controller finds a source LA corresponding to a QP having the largest traffic after analyzing all flows of the congested link through sflow, and aligns to deliver a 32-bit route. It can be clearly seen that the ECN counts almost decrease to 0 after scheduling. Specific data may refer to Table 6. Network congestion is immediately eliminated after scheduling.

TABLE 6
Details of ECN values in three minutes
before and after controller scheduling

| Serial number | Time | ECN value |
|---|---|---|
| 2526 | 08-10 16:59:00 | 0 |
| 2527 | 08-10 16:58:50 | 0 |
| 2528 | 08-10 16:58:40 | 0 |
| 2529 | 08-10 16:58:30 | 0 |
| 2530 | 08-10 16:58:20 | 0 |
| 2531 | 08-10 16:58:10 | 0 |
| 2532 | 08-10 16:58:00 | 0 |
| 2533 | 08-10 16:57:50 | 0 |
| 2534 | 08-10 16:57:40 | 0 |
| 2535 | 08-10 16:57:30 | 0 |
| 2536 | 08-10 16:57:20 | 0 |
| 2537 | 08-10 16:57:10 | 0 |
| 2538 | 08-10 16:57:00 | 0 |
| 2539 (receive an alarm + schedule) | 08-10 16:56:50 | 0 |
| 2540 | 08-10 16:56:40 | 878.80 |
| 2541 | 08-10 16:56:30 | 0 |
| 2542 | 08-10 16:56:20 | 0 |
| 2543 | 08-10 16:56:10 | 1284.70 |
| 2544 | 08-10 16:56:00 | 0 |
| 2545 | 08-10 16:55:50 | 1775.30 |
| 2546 | 08-10 16:55:40 | 214.50 |
| 2547 | 08-10 16:55:30 | 0 |
| 2548 | 08-10 16:55:20 | 887.90 |
| 2549 | 08-10 16:55:10 | 0 |
| 2550 | 08-10 16:55:00 | 375.60 |
| 2551 | 08-10 16:54:50 | 259.80 |
| 2552 | 08-10 16:54:40 | 0 |
| 2553 | 08-10 16:54:30 | 0 |
| 2554 | 08-10 16:54:20 | 0 |
| 2555 | 08-10 16:54:10 | 0 |
| 2556 | 08-10 16:54:00 | 0 |
| 2557 | 08-10 16:53:50 | 0 |
| 2558 | 08-10 16:53:40 | 490.70 |

The foregoing embodiment merely illustratively presents an implementation in which the controller delivers the BGP route to the source LA. The type of the route is not specifically limited in this embodiment of the present disclosure. Illustratively, the controller may deliver policy-based routing (PBR).

In summary, in the embodiments of the present disclosure, when network congestion occurs, the target traffic-forwarding path configured for forwarding the traffic of the to-be-scheduled out QP is determined based on the traffic of the links in the network to ensure that the target traffic-forwarding path can carry some traffic on the congested link. In addition, the changed route of the to-be-scheduled out QP is determined based on the target address of the to-be-scheduled out QP and the target traffic-forwarding path. The target traffic-forwarding path is controlled to output some traffic on the congested link by delivering the changed route to the target source LA, thereby resolving the network congestion problem. In addition, in the embodiments of the present disclosure, when link congestion occurs in the network, some traffic on the congested link starts to be scheduled from the source, i.e., the target source LA, thereby ensuring that the network congestion problem can be resolved quickly.

The following continues to describe an exemplary structure in which a network congestion scheduling apparatus 453 provided in the embodiments of the present disclosure is implemented as software modules. In some embodiments, as shown in FIG. 2B, the software modules in the network congestion scheduling apparatus 453 stored in the memory 440 may include: a first determining module 4531, a second determining module 4532, a third determining module 4533, a fourth determining module 4534, and a transmitting module 4535.

The first determining module 4531 is configured to determine, in response to link congestion in a network, a plurality of QPs on a congested link in the network.

The second determining module 4532 is configured to determine, from the plurality of QPs on the congested link, a to-be-scheduled out QP on the congested link.

The third determining module 4533 is configured to determine, based on traffic of links in the network, a target traffic-forwarding path configured for forwarding traffic of the to-be-scheduled out QP.

The fourth determining module 4534 is configured to determine a changed route of the to-be-scheduled out QP based on a target address of the to-be-scheduled out QP and the target traffic-forwarding path.

The transmitting module 4535 is configured to deliver the changed route to a target source LA of the to-be-scheduled out QP, the target source LA being configured to output, based on the changed route, the traffic of the to-be-scheduled out QP through the target traffic-forwarding path.

In the foregoing solution, the network congestion scheduling apparatus 453 further includes a fifth determining module. The fifth determining module is configured to determine the target source LA of the to-be-scheduled out QP; screen out, on a link from the target source LA to an LC, first QPs having a same target address as the to-be-scheduled out QP; and determine a sum of traffic of the first QPs as total forwarding traffic. The third determining module 4533 is further configured to determine, based on the total forwarding traffic and the traffic of the links in the network, the target traffic-forwarding path configured for forwarding the traffic of the to-be-scheduled out QP.

In the foregoing solution, the third determining module 4533 is further configured to screen, based on load rates of a plurality of candidate links from an LA to the LC in the network, the plurality of candidate links to obtain a candidate link set, where the candidate link set includes at least one candidate link; and determine, based on the total forwarding traffic and the candidate link set, the target traffic-forwarding path configured for forwarding the traffic of the to-be-scheduled out QP

In the foregoing solution, the third determining module 4533 is further configured to select a target candidate link from the at least one candidate link included in the candidate link set; determine, when remaining bandwidth of each link in upstream links containing the target candidate link is capable of carrying the total forwarding traffic and remaining bandwidth of each link in downstream links of the target candidate link is capable of carrying the total forwarding traffic, a path formed based on the target candidate link and the downstream links as the target traffic-forwarding path; and end an iteration when an iteration stop condition is met, where the iteration stop condition includes one of the following: determining the target traffic-forwarding path; and the candidate link set being null.

In the foregoing solution, the third determining module 4533 is further configured to remove, when remaining bandwidth of any link in the upstream links including the target candidate link is incapable of carrying the total forwarding traffic or remaining bandwidth of any link in the downstream links of the target candidate link is incapable of carrying the total forwarding traffic, the target candidate link from the candidate link set to obtain a new candidate link set, where the new candidate link set is configured for continuing the iteration.

In the foregoing solution, when the target candidate link is located in a Layer 2 architecture, the downstream links include a link from the LC to a destination LA.

When the target candidate link is located in a Layer 3 architecture, the upstream links further include a link from the LC to a Super-LC through which the to-be-scheduled out QP passes, and the downstream links further include a link from the super-LC to a downstream LC and a link from the downstream LC to the destination LA.

In the foregoing solution, the third determining module 4533 is further configured to determine, when a load rate of any candidate link is less than a load rate threshold, a set formed by the candidate link as the candidate link set; or sort the plurality of candidate links in ascending order based on the load rates of the plurality of candidate links, and determine a set of some candidate links sorted top in a sorting result as the candidate link set, where the load rate includes one of the following: a historical load rate in a plurality of sampling periods, a real-time load rate, and a load rate obtained by mapping the historical load rate and the real-time load rate.

In the foregoing solution, the third determining module 4533 is further configured to perform, when the historical load rate is less than a first load rate threshold and the real-time load rate is less than a second load rate threshold, weighted summation on the historical load rate and the real-time load rate to obtain the load rate obtained by mapping the historical load rate and the real-time load rate.

In the foregoing solution, when there are a plurality of target traffic-forwarding paths and the traffic of the to-be-scheduled out QP is incapable of being outputted through a sampled target traffic-forwarding path, the traffic of the to-be-scheduled out QP is outputted based on another target traffic-forwarding path, where the another target traffic-forwarding path is a target traffic-forwarding path except the sampled target traffic-forwarding path in the plurality of target traffic-forwarding paths.

In the foregoing solution, the network congestion scheduling apparatus 453 further includes a recovery module. The recovery module is configured to collect statistics on duration of the traffic of the to-be-scheduled out QP passing through the target traffic-forwarding path; and deliver, in response to the duration reaching a preset time, a recovery instruction to the target source LA of the to-be-scheduled out QP, where the recovery instruction is configured for instructing the target source LA to output the traffic of the to-be-scheduled out QP based on a recovered congested link.

In the foregoing solution, the network congestion scheduling apparatus 453 further includes the recovery module. The recovery module is configured to detect a congestion degree of the congested link; and deliver, in response to the congestion degree representing that the congested link is recovered to be normal, the recovery instruction to the target source LA of the to-be-scheduled out QP, where the recovery instruction is configured for instructing the target source LA to output the traffic of the to-be-scheduled out QP based on the recovered congested link.

In the foregoing solution, the second determining module is further configured to determine traffic parameters of the QPs on the congested link in the plurality of sampling periods; and screen out the to-be-scheduled out QP from the plurality of QPs on the congested link based on the traffic parameters, where the traffic parameter includes one of the following: a traffic peak, an average traffic value, and a traffic value obtained after performing weighted summation on the traffic based on duration of the traffic in the plurality of sampling periods.

The embodiments of the present disclosure provide a computer program product or a computer program, including a computer instruction. The computer instruction is stored in a computer-readable storage medium. A processor of a controller reads the computer instruction from the computer-readable storage medium and executes the computer instruction to cause the controller to perform the foregoing scheduling method for managing network congestion provided in the embodiments of the present disclosure.

The embodiments of the present disclosure provide a computer-readable storage medium, having a computer-executable instruction stored therein. The computer-readable storage medium has a computer-executable instruction or a computer program stored therein. When the computer-executable instruction or the computer program is executed by a processor, the processor is enabled to perform the scheduling method for managing network congestion provided in the embodiments of the present disclosure, for example, the scheduling method for managing network congestion shown in FIG. 3A.

In some embodiments, the computer-readable storage medium may be a memory such as a ferroelectric RAM (FRAM), a ROM, a programmable ROM (PROM), an electrically programmable ROM (EPROM), an electrically erasable PROM (EEPROM), a flash memory, a magnetic surface memory, an optical disk, or a CD-ROM, or may be any device including one of or any combination of the foregoing memories.

In some embodiments, the computer-executable instruction may be written in the form of a program, software, software module, script, or code in any form of programming language (including compilation or interpretation language, or declarative or procedural language), and may be deployed in any form, including being deployed as an independent program or being deployed as a module, component, subroutine, or another unit suitable for use in a computing environment.

As an example, the computer-executable instruction may but may not necessarily correspond to a file in a file system, may be stored in a part of the file for storing other programs or data, for example, stored in one or more scripts in a hyper text markup language (HTML) document, stored in a single file dedicated to the discussed program, or stored in a plurality of collaborative files (for example, files storing one or more modules, a subprogram, or a code part).

As an example, the computer-executable instruction may be deployed to be executed on one electronic device, on a plurality of electronic devices located at one location, or on a plurality of electronic devices distributed at a plurality of locations and interconnected through a communication network.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

In the embodiments of the present disclosure, relevant data such as user information is involved. When the embodiments of the present disclosure are applied to specific products or technologies, user permission or consent needs to be obtained, and the acquisition, use, and processing of relevant data need to comply with relevant laws, regulations, and standards of relevant countries and regions.

The embodiments of the present disclosure have the following beneficial effects. When network congestion occurs, the target traffic-forwarding path configured for forwarding the traffic of the to-be-scheduled out QP is determined based on the traffic of the links in the network to ensure that the target traffic-forwarding path can carry some traffic on the congested link. In addition, the changed route of the to-be-scheduled out QP is determined based on the target address of the to-be-scheduled out QP and the target traffic-forwarding path. The target traffic-forwarding path is controlled to output some traffic on the congested link by delivering the changed route to the target source LA, thereby resolving the network congestion problem. In addition, in the embodiments of the present disclosure, when link congestion occurs in the network, some traffic on the congested link starts to be scheduled from the source, i.e., the target source LA, thereby ensuring that the network congestion problem can be resolved quickly.

The foregoing descriptions are merely embodiments of the present disclosure and are not intended to limit the protection scope of the present disclosure. Any modification, equivalent replacement, or improvement made within the spirit and scope of the present disclosure fall within the protection scope of the present disclosure.

What is claimed is:

1. A scheduling method for managing network congestion, applied to an electronic device, and comprising:
determining, in response to link congestion in a network, a plurality of queue pairs (QPs) on a congested link in the network;
determining, from the plurality of QPs on the congested link, a target QP for scheduling out from the congested link;
determining a target traffic-forwarding path based on traffic of links in the network, the target traffic-forwarding path being configured for forwarding traffic of the target QP;
determining a changed route of the target QP based on a target address of the target QP and the target traffic-forwarding path; and
delivering the changed route to a target source local area network access (LA) device of the target QP, the target source LA device being configured to output, based on the changed route, the traffic of the target QP through the target traffic-forwarding path.

2. The method according to claim 1, further comprising:
determining the target source LA device of the target QP; screening out, on a link from the target source LA device to a LAN core (LC) device, first QPs having a same target address as the target QP; and determining a sum of traffic of the first QPs as total forwarding traffic; and/or
determining the target traffic-forwarding path based on the total forwarding traffic and the traffic of the links in the network.

3. The method according to claim 2, wherein determining the target traffic-forwarding path based on the total forwarding traffic and the traffic of the links in the network comprises:
screening, based on load rates of a plurality of candidate links from an LA device to the LC device in the network, the plurality of candidate links to obtain a candidate link set, wherein the candidate link set comprises at least one candidate link; and
determining the target traffic-forwarding path based on the total forwarding traffic and the candidate link set.

4. The method according to claim 3, wherein determining the target traffic-forwarding path based on the total forwarding traffic and the candidate link set comprises:
iteratively performing following processing:
selecting a target candidate link from the at least one candidate link comprised in the candidate link set, and determining remaining bandwidth of the target candidate link; and
determining, when remaining bandwidth of each link in upstream links comprising the target candidate link is capable of carrying the total forwarding traffic and remaining bandwidth of each link in downstream links of the target candidate link is capable of carrying the total forwarding traffic, a path formed based on the target candidate link and the downstream links as the target traffic-forwarding path; and
ending an iteration when an iteration stop condition is met, wherein the iteration stop condition comprises one of following: the target traffic-forwarding path being determined;
and the candidate link set being null.

5. The method according to claim 4, further comprising:
removing, when remaining bandwidth of any link in the upstream links comprising the target candidate link is incapable of carrying the total forwarding traffic or remaining bandwidth of any link in the downstream links of the target candidate link is incapable of carrying the total forwarding traffic, the target candidate link from the candidate link set to obtain a new candidate link set,
wherein the new candidate link set is configured for continuing the iteration.

6. The method according to claim 4, wherein
when the target candidate link is located in a Layer 2 architecture, the downstream links comprise a link from the LC device to a destination LA device; and
when the target candidate link is located in a Layer 3 architecture, the upstream links further comprise a link from the LC device to a Super-LC device through which the target QP passes, and the downstream links further comprise a link from the super-LC device to a downstream LC device and a link from the downstream LC device to the destination LA device.

7. The method according to claim 3, wherein screening, based on load rates of the plurality of candidate links from the LA device to the LC device in the network, the plurality of candidate links to obtain the candidate link set comprises:
determining, when a load rate of any candidate link is less than a load rate threshold, a set formed by the candidate link as the candidate link set; and/or
sorting the plurality of candidate links in ascending order based on the load rates of the plurality of candidate links, and determining a set of some candidate links sorted top in a sorting result as the candidate link set,
wherein the load rate comprises one of following: a historical load rate in a plurality of sampling periods, a real-time load rate, and a load rate obtained by mapping the historical load rate and the real-time load rate.

8. The method according to claim 7, wherein the load rate obtained by mapping the historical load rate and the real-time load rate is determined in following manner:
performing, when the historical load rate is less than a first load rate threshold and the real-time load rate is less than a second load rate threshold, weighted summation on the historical load rate and the real-time load rate to obtain the load rate obtained by mapping the historical load rate and the real-time load rate.

9. The method according to claim 1, wherein when there are a plurality of target traffic-forwarding paths and the traffic of the target QP is incapable of being outputted through a sampled target traffic-forwarding path, the traffic of the target QP is outputted based on another target traffic-forwarding path, wherein the another target traffic-forwarding path is a target traffic-forwarding path except the sampled target traffic-forwarding path in the plurality of target traffic-forwarding paths.

10. The method according to claim 1, further comprising:
collecting statistics on duration of the traffic of the target QP passing through the target traffic-forwarding path; and
delivering, in response to the duration reaching a preset time, a recovery instruction to the target source LA device of the target QP, wherein the recovery instruction is configured for instructing the target source LA device to output the traffic of the target QP based on a recovered congested link.

11. The method according to claim 1, further comprising:
detecting a congestion degree of the congested link; and
delivering, in response to the congestion degree representing that the congested link is recovered to be normal, the recovery instruction to the target source LA of the target QP, wherein the recovery instruction is configured for instructing the target source LA to output the traffic of the target QP based on the recovered congested link.

12. The method according to claim 1, wherein determining, from the plurality of QPs on the congested link, the target QP on the congested link comprises:
determining traffic parameters of the QPs on the congested link in the plurality of sampling periods, wherein the traffic parameter comprises one of the following: a traffic peak, an average traffic value, and a traffic value obtained after performing weighted summation on the traffic based on duration of the traffic in the plurality of sampling periods; and
screening out the target QP from the plurality of QPs on the congested link based on the traffic parameters.

13. An electronic device, comprising:
one or more processors and a memory containing a computer-executable instruction that, when being executed, causes the one or more processors to perform:
determining, in response to link congestion in a network, a plurality of queue pairs (QPs) on a congested link in the network;
determining, from the plurality of QPs on the congested link, a target QP for scheduling out from the congested link;
determining a target traffic-forwarding path based on traffic of links in the network, the target traffic-forwarding path being configured for forwarding traffic of the target QP;
determining a changed route of the target QP based on a target address of the target QP and the target traffic-forwarding path; and
delivering the changed route to a target source local area network access (LA) device of the target QP, the target source LA device being configured to output, based on the changed route, the traffic of the target QP through the target traffic-forwarding path.

14. The device according to claim 13, wherein the one or more processors are further configured to perform:
determining the target source LA device of the target QP; screening out, on a link from the target source LA device to a LAN core (LC) device, first QPs having a same target address as the target QP; and determining a sum of traffic of the first QPs as total forwarding traffic; and/or
determining the target traffic-forwarding path based on the total forwarding traffic and the traffic of the links in the network.

15. The device according to claim 14, wherein the one or more processors are further configured to perform:
screening, based on load rates of a plurality of candidate links from an LA device to the LC device in the network, the plurality of candidate links to obtain a candidate link set, wherein the candidate link set comprises at least one candidate link; and
determining the target traffic-forwarding path based on the total forwarding traffic and the candidate link set.

16. The device according to claim 15, wherein the one or more processors are further configured to perform:
iteratively performing following processing:
selecting a target candidate link from the at least one candidate link comprised in the candidate link set, and determining remaining bandwidth of the target candidate link; and
determining, when remaining bandwidth of each link in upstream links comprising the target candidate link is capable of carrying the total forwarding traffic and remaining bandwidth of each link in downstream links of the target candidate link is capable of carrying the total forwarding traffic, a path formed based on the target candidate link and the downstream links as the target traffic-forwarding path; and
ending an iteration when an iteration stop condition is met, wherein the iteration stop condition comprises one of following: the target traffic-forwarding path being determined;
and the candidate link set being null.

17. The device according to claim 16, wherein the one or more processors are further configured to perform:
removing, when remaining bandwidth of any link in the upstream links comprising the target candidate link is incapable of carrying the total forwarding traffic or remaining bandwidth of any link in the downstream links of the target candidate link is incapable of carrying the total forwarding traffic, the target candidate link from the candidate link set to obtain a new candidate link set,
wherein the new candidate link set is configured for continuing the iteration.

18. The device according to claim 16, wherein
when the target candidate link is located in a Layer 2 architecture, the downstream links comprise a link from the LC device to a destination LA device; and
when the target candidate link is located in a Layer 3 architecture, the upstream links further comprise a link from the LC device to a Super-LC device through which the target QP passes, and the downstream links further comprise a link from the super-LC device to a downstream LC device and a link from the downstream LC device to the destination LA device.

19. The device according to claim 15, wherein the one or more processors are further configured to perform:
determining, when a load rate of any candidate link is less than a load rate threshold, a set formed by the candidate link as the candidate link set; and/or
sorting the plurality of candidate links in ascending order based on the load rates of the plurality of candidate links, and determining a set of some candidate links sorted top in a sorting result as the candidate link set,
wherein the load rate comprises one of following: a historical load rate in a plurality of sampling periods, a real-time load rate, and a load rate obtained by mapping the historical load rate and the real-time load rate.

20. A non-transitory computer-readable storage medium containing a computer program that, when being executed, causes at least one processor to perform:
determining, in response to link congestion in a network, a plurality of queue pairs (QPs) on a congested link in the network;
determining, from the plurality of QPs on the congested link, a target QP for scheduling out from the congested link;
determining a target traffic-forwarding path based on traffic of links in the network, the target traffic-forwarding path being configured for forwarding traffic of the target QP;
determining a changed route of the target QP based on a target address of the target QP and the target traffic-forwarding path; and
delivering the changed route to a target source local area network access (LA) device of the target QP, the target source LA device being configured to output, based on the changed route, the traffic of the target QP through the target traffic-forwarding path.
